(19) United States
(12) Patent Application Publication
(10) Pub. No.: US 2021/0231535 A1
(43) Pub. Date: Jul. 29, 2021

(54) ABNORMALITY DETECTION DEVICE AND ABNORMALITY DETECTION METHOD

(71) Applicant: Mitsubishi Electric Corporation, Tokyo (JP)

(72) Inventor: Takaaki NAKAMURA, Tokyo (JP)

(73) Assignee: Mitsubishi Electric Corporation, Tokyo (JP)

(21) Appl. No.: 17/232,565

(22) Filed: Apr. 16, 2021

Related U.S. Application Data
(63) Continuation of application No. PCT/JP2018/044643, filed on Dec. 5, 2018.

(51) Int. Cl. G01M 99/00; G06F 16/23; G06N 20/00

(52) U.S. Cl. CPC G01M 99/005; G06N 20/00; G06F 16/2365

(57) ABSTRACT

An abnormality detection device is configured so as to include: an outlier score calculating unit for calculating, from abnormality detection time-series data indicating states of equipment which is an abnormality detection target at a plurality of times in time series, a degree of abnormality of the equipment at each of the plurality of times as an abnormality detection outlier score; an outlier data extracting unit for extracting, from among pieces of the abnormality detection time-series data, a piece of abnormality detection time-series data in a time period in which an abnormality may have occurred in the equipment as abnormality detection outlier data on the basis of the abnormality detection outlier score at each of the plurality of times calculated by the outlier score calculating unit; and an abnormality determining unit for collating a waveform of the abnormality detection outlier data extracted by the outlier data extracting unit with a waveform condition for determining that a waveform indicating a change in the abnormality detection outlier data is a waveform obtained when the equipment is operating normally, and determining whether or not the equipment is operating abnormally on the basis of a collation result between the waveform condition and the waveform of the abnormality detection outlier data.

### CROSS REFERENCE TO RELATED APPLICATIONS

This application is a Continuation of PCT International Application No. PCT/JP2018/044643 filed on Dec. 5, 2018, which is hereby expressly incorporated by reference into the present application.

### TECHNICAL FIELD

The present invention relates to an abnormality detection device and an abnormality detection method for determining whether or not equipment is operating abnormally.

### BACKGROUND ART

A conventional abnormality detection method for detecting abnormality of equipment compares abnormality detection time-series data indicating states of equipment at a plurality of times in time series with time-series data at normal time collected when the equipment is operating normally.

The conventional abnormality detection method detects abnormality of equipment by detecting time-series data of a part whose behavior is different from that of time-series data at normal time (hereinafter, referred to as “subsequence data”) from among pieces of abnormality detection time-series data.

However, the subsequence data is time-series data in a time period in which abnormality may have occurred in the equipment, but abnormality has not necessarily occurred in the equipment, and the equipment may be operating normally.

The following Patent Literature 1 discloses an abnormality detection system for detecting abnormality of equipment by combining a conventional abnormality detection method and a method for analyzing event information in order to avoid occurrence of an erroneous determination indicating that abnormality has occurred in the equipment when the equipment is operating normally.

Examples of the event information include information indicating an event related to operation of equipment by a worker and information indicating an event related to replacement of parts of the equipment.

The abnormality detection system disclosed in Patent Literature 1 determines that no abnormality has occurred in equipment even when detecting subsequence data as long as the detected subsequence data is synchronized with an event indicated by event information.

### CITATION LIST

### Patent Literature

Patent Literature 1: JP 2013-218725 A

### SUMMARY OF INVENTION

### Technical Problem

The abnormality detection system disclosed in Patent Literature 1 needs to hold event information in advance.

In a case where the abnormality detection system disclosed in Patent Literature 1 cannot prepare event information in advance, when the abnormality detection system detects subsequence data while equipment is operating normally, the abnormality detection system erroneously determines that abnormality has occurred in the equipment disadvantageously.

The present invention has been achieved in order to solve the above-described problem, and an object of the present invention is to obtain an abnormality detection device and an abnormality detection method capable of avoiding occurrence of an erroneous determination indicating that abnormality has occurred in equipment without preparing event information in advance.

### Solution to Problem

An abnormality detection device according to the present invention includes: processing circuitry to calculate, from abnormality detection time-series data indicating states of equipment which is an abnormality detection target at a plurality of times in time series, the degree of abnormality of the equipment at each of the plurality of times as an abnormality detection outlier score; to extract, from among pieces of the abnormality detection time-series data, a piece of abnormality detection time-series data in a time period in which an abnormality may have occurred in the equipment as abnormality detection outlier data on the basis of the abnormality detection outlier score at each of the plurality of times; to collate a waveform of the abnormality detection outlier data with a waveform condition for determining that a waveform indicating a change in the abnormality detection outlier data is a waveform obtained when the equipment is operating normally, to determine whether or not the equipment is operating abnormally on the basis of a collation result between the waveform condition and the waveform of the abnormality detection outlier data; to calculate a feature amount of the abnormality detection outlier data, and to determine a waveform type of the abnormality detection outlier data from the feature amount; to select a waveform condition corresponding to the type from among one or more waveform conditions; to collate the waveform condition with the waveform of the abnormality detection outlier data, and to determine whether or not the equipment is operating abnormally on a basis of a collation result between the selected waveform condition and the waveform of the abnormality detection outlier data; to calculate, from each of one or more pieces of learning time-series data indicating states of the equipment at a plurality of times when the equipment is operating normally in time series, a degree of abnormality of the equipment at each of the plurality of times as a learning outlier score; to extract, from among the pieces of learning time-series data, learning time-series data in a time period in which an abnormality may have occurred in the equipment as learning outlier data on a basis of the learning outlier score at each of the plurality of times; to calculate a feature amount of each of the pieces of learning outlier data, and to determine a waveform type of each of the pieces of learning outlier data from the feature amount of each of the pieces of learning outlier data, and to generate, from among waveforms of one or more pieces of learning outlier data whose waveforms have been determined to be of the same type out of the pieces of learning outlier data, a waveform condition corresponding to the type.

### Advantageous Effects of Invention

According to the present invention, the abnormality detection device is configured in such a manner that the processing circuitry collates a waveform of the abnormality detection outlier data with a waveform condition for determining that a waveform indicating a change in the abnormality detection outlier data is a waveform obtained when the equipment is operating normally, and determines whether or not the equipment is operating abnormally on the basis of a collation result between the waveform condition and the waveform of the abnormality detection outlier data. Therefore, the abnormality detection device according to the present invention can avoid occurrence of erroneous determination indicating that an abnormality has occurred in the equipment without preparing event information in advance.

### BRIEF DESCRIPTION OF DRAWINGS

FIG. 1 is a configuration diagram illustrating an abnormality detection device according to a first embodiment.

FIG. 2 is a hardware configuration diagram illustrating hardware of the abnormality detection device according to the first embodiment.

FIG. 3 is a hardware configuration diagram of a computer when an abnormality detection device is achieved by software, firmware, or the like.

FIG. 4 is a flowchart illustrating a processing procedure during learning in the abnormality detection device.

FIG. 5 is a flowchart illustrating an abnormality detection method which is a processing procedure during abnormality detection in the abnormality detection device.

FIG. 6A is an explanatory diagram illustrating an example of learning time-series data D_{G,n,t}, and FIG. 6B is an explanatory diagram illustrating examples of a learning outlier score S_{G,n,t} and a threshold Sₜₕ.

FIG. 7A is an explanatory diagram illustrating an example of a waveform of learning outlier data OD_{G,n,ts-te} when the waveform type is “upper peak type”, FIG. 7B is an explanatory diagram illustrating an example of a waveform of learning outlier data OD_{G,n,ts-te} when the waveform type is “lower peak type”, FIG. 7C is an explanatory diagram illustrating an example of a waveform of learning outlier data OD_{G,n,ts-te} when the waveform type is “upper and lower peak type”, FIG. 7D is an explanatory diagram illustrating an example of a waveform of learning outlier data OD_{G,n,ts-te} when the waveform type is “transient ascending type”, FIG. 7E is an explanatory diagram illustrating an example of a waveform of learning outlier data OD_{G,n,ts-te} when the waveform type is “transient descending type”, and FIG. 7F is an explanatory diagram illustrating an example of a waveform of learning outlier data OD_{G,n,ts-te} when the waveform type is “vibration type”.

FIG. 8 is an explanatory diagram illustrating an example of a feature amount C_{G,n} of learning outlier data OD_{G,n,ts-te}.

FIG. 9A is an explanatory diagram illustrating N (N=12) pieces of learning outlier data OD_{G,n,ts-te} having a waveform type of “upper peak type”, and FIG. 9B is an explanatory diagram illustrating a mean value Pₘₑₐₙ [t] of the N pieces of learning outlier data OD_{G,n,ts-te}, and an upper limit value Bᵤₚₚₑᵣ [t] and a lower limit value B_{lower} [t] of a normal range indicated by a band model.

FIG. 10A is an explanatory diagram illustrating a waveform of abnormality detection outlier data OD_{U,ts′-te′} when an abnormality determination processing unit 11 determines that equipment is operating normally, and FIG. 10B is an explanatory diagram illustrating a waveform of abnormality detection outlier data OD_{U,ts′-te′} when the abnormality determination processing unit 11 determines that the equipment is operating abnormally.

FIG. 11 is an explanatory diagram illustrating an example of a histogram generated by a waveform condition generation processing unit 14.

FIG. 12 is a configuration diagram illustrating an abnormality detection device according to a third embodiment.

FIG. 13 is a hardware configuration diagram illustrating hardware of the abnormality detection device according to the third embodiment.

FIG. 14 is an explanatory diagram illustrating a list confirmation screen displaying a list of one or more waveform conditions Wp generated by the waveform condition generation processing unit 14.

FIG. 15 is an explanatory diagram illustrating a list confirmation screen displaying a list of pieces of learning outlier data OD_{G,n,ts-te} from which a waveform conditions Wp has been generated.

FIG. 16 is a configuration diagram illustrating an abnormality detection device according to a fourth embodiment.

FIG. 17 is a hardware configuration diagram illustrating hardware of the abnormality detection device according to the fourth embodiment.

FIG. 18 is an explanatory diagram illustrating an example of a data display screen displaying pieces of abnormality detection outlier data OD_{U,ts′-te′} collated with waveform conditions Wp and pieces of abnormality detection time-series data D_{U,t} when the abnormality determination processing unit 11 determines that equipment is operating abnormally.

### DESCRIPTION OF EMBODIMENTS

Hereinafter, in order to describe the present invention in more detail, embodiments for performing the present invention will be described by referring to the attached drawings.

### First Embodiment

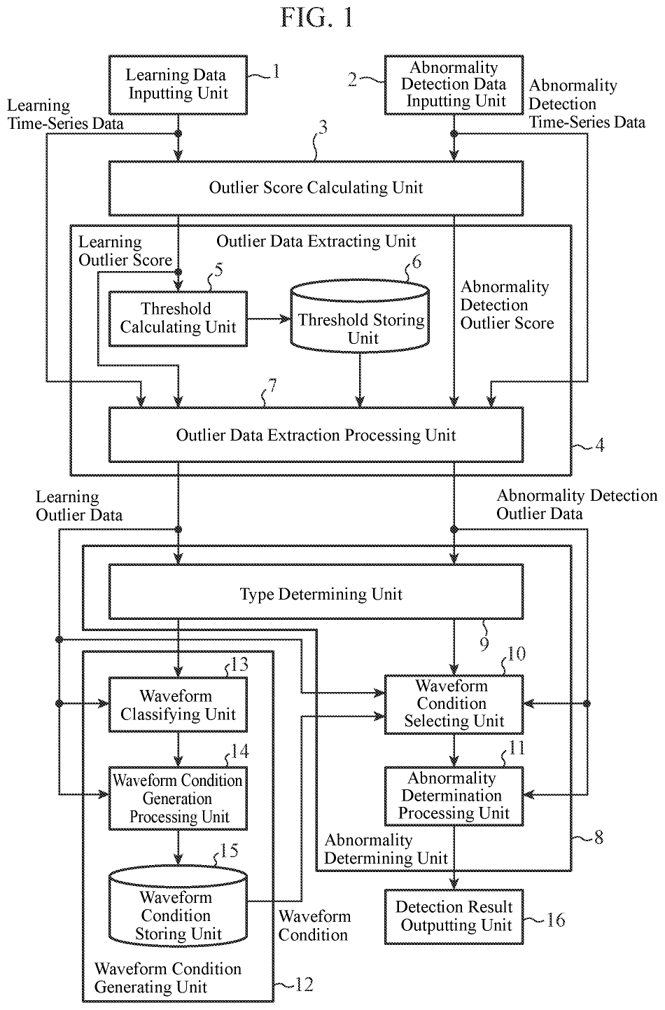

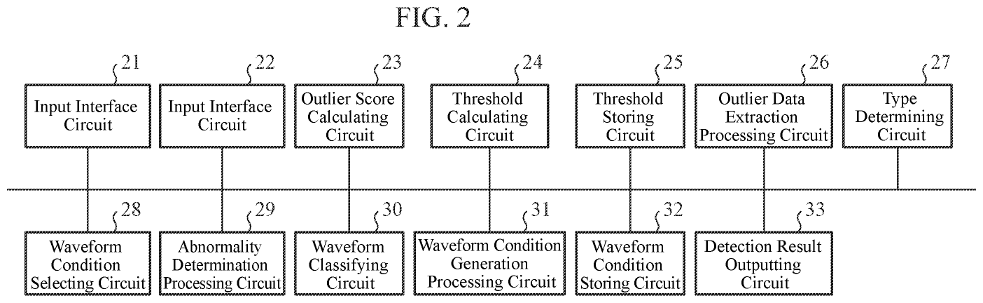

FIG. 1 is a configuration diagram illustrating an abnormality detection device according to a first embodiment. FIG. 2 is a hardware configuration diagram illustrating hardware of the abnormality detection device according to the first embodiment.

In FIGS. 1 and 2, a learning data inputting unit 1 is achieved by, for example, an input interface circuit 21 illustrated in FIG. 2.

The learning data inputting unit 1 receives input of N pieces of learning time-series data D_{G,n,t} (n=1, 2, . . . , N) indicating states of equipment which is an abnormality detection target at a plurality of times tin time series when the equipment is operating normally. N is an integer equal to or more than 1.

The learning time-series data D_{G,n,t} includes an observed value of a sensor at each time t, and the observed value of the sensor indicates a state of the equipment.

The learning data inputting unit 1 outputs the received learning time-series data D_{G,n,t} to each of an outlier score calculating unit 3 and an outlier data extraction processing unit 7.

As the equipment which is an abnormality detection target, equipment such as a power plant, a chemical plant, or a water and sewage plant is conceivable. In addition, as the equipment which is an abnormality detection target, air conditioning equipment, electrical equipment, lighting equipment, water supply and drainage equipment, or the like in an office building or a factory is conceivable. In addition, equipment such as a conveyor constituting a production line of a factory, equipment installed in an automobile, or equipment installed in a railway vehicle is conceivable. Furthermore, as the equipment which is an abnormality detection target, equipment of an information system related to economy or equipment of an information system related to management is also conceivable.

An abnormality detection data inputting unit 2 is achieved by, for example, an input interface circuit 22 illustrated in FIG. 2.

The abnormality detection data inputting unit 2 receives input of abnormality detection time-series data D_{U,t} indicating states of equipment which is an abnormality detection target at a plurality of times tin time series.

The abnormality detection time-series data D_{U,t} includes an observed value of a sensor at each time t, and the observed value of the sensor indicates a state of the equipment.

The abnormality detection data inputting unit 2 outputs the received abnormality detection time-series data D_{U,t} to each of the outlier score calculating unit 3 and the outlier data extraction processing unit 7.

The outlier score calculating unit 3 is achieved by, for example, an outlier score calculating circuit 23 illustrated in FIG. 2.

The outlier score calculating unit 3 calculates the degree of abnormality of the equipment at each time t as a learning outlier score S_{G,n,t} from each of the N pieces of learning time-series data D_{G,n,t} output from the learning data inputting unit 1. The outlier score calculating unit 3 outputs the calculated learning outlier score S_{G,n,t} at each time t to an outlier data extracting unit 4.

The outlier score calculating unit 3 calculates the degree of abnormality of the equipment at each time t as an abnormality detection outlier score S_{U,t} from the abnormality detection time-series data D_{U,t} output from the abnormality detection data inputting unit 2. The outlier score calculating unit 3 outputs the calculated abnormality detection outlier score S_{U,t} at each time t to the outlier data extracting unit 4.

The outlier data extracting unit 4 includes a threshold calculating unit 5, a threshold storing unit 6, and the outlier data extraction processing unit 7.

The outlier data extracting unit 4 extracts time-series data in a time period in which an abnormality may have occurred in the equipment as learning outlier data OD_{G,n} from among pieces of the learning time-series data D_{G,n,t} on the basis of the learning outlier score S_{G,n,t} calculated by the outlier score calculating unit 3. The outlier data extracting unit 4 outputs the extracted learning outlier data OD_{G,n} to each of an abnormality determining unit 8 and a waveform condition generating unit 12.

The outlier data extracting unit 4 extracts abnormality detection time-series data in a time period in which an abnormality may have occurred in the equipment as abnormality detection outlier data OD_{U,ts′-te′} from among pieces of the abnormality detection time-series data D_{U,t} on the basis of the abnormality detection outlier score S_{U,t} calculated by the outlier score calculating unit 3. The outlier data extracting unit 4 outputs the extracted abnormality detection outlier data OD_{U,ts′-te′} to the abnormality determining unit 8.

The threshold calculating unit 5 is achieved by, for example, a threshold calculating circuit 24 illustrated in FIG. 2.

The threshold calculating unit 5 calculates a threshold Sₜₕ from the learning outlier score S_{G,n,t} calculated by the outlier score calculating unit 3, and outputs the threshold Sₜₕ to the threshold storing unit 6.

The threshold storing unit 6 is achieved by, for example, a threshold storing circuit 25 illustrated in FIG. 2.

The threshold storing unit 6 stores the threshold Sₜₕ output from the threshold calculating unit 5.

The outlier data extraction processing unit 7 is achieved by, for example, an outlier data extraction processing circuit 26 illustrated in FIG. 2.

The outlier data extraction processing unit 7 compares the learning outlier score S_{G,n,t} calculated by the outlier score calculating unit 3 at each time t with the threshold Sₜₕ stored by the threshold storing unit 6.

The outlier data extraction processing unit 7 extracts learning outlier data OD_{G,n,ts-te} from among pieces of the learning time-series data D_{G,n,t} on the basis of a comparison result between the learning outlier score S_{G,n,t} at each time t and the threshold Sₜₕ. The outlier data extraction processing unit 7 outputs the extracted learning outlier data OD_{G,n,ts-te} to each of a type determining unit 9, a waveform condition selecting unit 10, a waveform classifying unit 13, and a waveform condition generation processing unit 14.

The outlier data extraction processing unit 7 compares the abnormality detection outlier score S_{U,t} calculated by the outlier score calculating unit 3 at each time t with the threshold Sₜₕ stored by the threshold storing unit 6.

The outlier data extraction processing unit 7 extracts abnormality detection outlier data OD_{U,ts′-te′} from among pieces of the abnormality detection time-series data D_{U,t} on the basis of a comparison result between the abnormality detection outlier score S_{U,t} at each time t and the threshold Sₜₕ. The outlier data extraction processing unit 7 outputs the extracted abnormality detection outlier data OD_{U,ts′-te′} to each of the type determining unit 9, the waveform condition selecting unit 10, and an abnormality determination processing unit 11.

The abnormality determining unit 8 includes the type determining unit 9, the waveform condition selecting unit 10, and the abnormality determination processing unit 11.

The abnormality determining unit 8 collates a waveform condition Wp with a waveform of the abnormality detection outlier data OD_{U,ts′-te′} extracted by the outlier data extracting unit 4. The waveform condition Wp is a condition for determining that a waveform indicating a change in the abnormality detection outlier data OD_{U,ts′-te′} extracted by the outlier data extracting unit 4 is a waveform obtained when the equipment is operating normally.

The abnormality determining unit 8 determines whether or not the equipment is operating abnormally on the basis of a collation result between the waveform condition Wp and the waveform of the abnormality detection outlier data OD_{U,ts′-te′}, and outputs a determination result indicating whether or not the equipment is operating abnormally to a detection result outputting unit 16.

The type determining unit 9 is achieved by, for example, a type determining circuit 27 illustrated in FIG. 2.

The type determining unit 9 calculates a feature amount C_{G,n} of the learning outlier data OD_{G,n,ts-te} extracted by the outlier data extraction processing unit 7, and determines the waveform type of the learning outlier data OD_{G,n,ts-te} from the feature amount C_{G,n}. The type determining unit 9 outputs the determined waveform type of the learning outlier data OD_{G,n,ts-te} to the waveform classifying unit 13.

The type determining unit 9 calculates a feature amounts Cu of the abnormality detection outlier data OD_{U,ts′-te′} extracted by the outlier data extraction processing unit 7, and determines the waveform type of the abnormality detection outlier data OD_{U,ts′-te′} from the feature amount Cu. The type determining unit 9 outputs the determined waveform type of the abnormality detection outlier data OD_{U,ts′-te′} to the waveform condition selecting unit 10.

The waveform condition selecting unit 10 is achieved by, for example, a waveform condition selecting circuit 28 illustrated in FIG. 2.

The waveform condition selecting unit 10 selects a waveform condition Wp corresponding to the type determined by the type determining unit 9 from among one or more waveform conditions Wp stored in a waveform condition storing unit 15, and outputs the selected waveform condition Wp to the abnormality determination processing unit 11.

The abnormality determination processing unit 11 is achieved by, for example, an abnormality determination processing circuit 29 illustrated in FIG. 2.

The abnormality determination processing unit 11 collates the waveform condition Wp selected by the waveform condition selecting unit 10 with the waveform of the abnormality detection outlier data OD_{U,ts′-te′} extracted by the outlier data extraction processing unit 7.

The abnormality determination processing unit 11 determines whether or not the equipment is operating abnormally on the basis of a collation result between the waveform condition Wp and the waveform of abnormality detection outlier data OD_{U,ts′-te′}, and outputs a determination result indicating whether or not the equipment is operating abnormally to the detection result outputting unit 16.

The waveform condition generating unit 12 includes the waveform classifying unit 13, the waveform condition generation processing unit 14, and the waveform condition storing unit 15.

The waveform condition generating unit 12 generates, from waveforms of one or more pieces of learning outlier data OD_{G,n,ts-te} whose waveforms have been determined to be of the same type by the type determining unit 9 out of the pieces of learning outlier data OD_{G,n,ts-te} extracted by the outlier data extracting unit 4, a waveform condition corresponding to the type. The waveform condition generating unit 12 stores the generated waveform condition.

The waveform classifying unit 13 is achieved by, for example, a waveform classifying circuit 30 illustrated in FIG. 2.

The waveform classifying unit 13 calculates the degree of similarity between one or more pieces of learning outlier data OD_{G,n,ts-te} whose waveforms have been determined to be of the same type by the type determining unit 9 out of the pieces of learning outlier data OD_{G,n,ts-te} extracted by the outlier data extracting unit 4.

The waveform classifying unit 13 classifies one or more pieces of learning outlier data OD_{G,n,ts-te} whose waveforms have been determined to be of the same type by the type determining unit 9 into groups on the basis of the calculated degree of similarity.

The waveform classifying unit 13 outputs a classification result of one or more pieces of learning outlier data OD_{G,n,ts-te} to the waveform condition generation processing unit 14.

The waveform condition generation processing unit 14 is achieved by, for example, a waveform condition generation processing circuit 31 illustrated in FIG. 2.

The waveform condition generation processing unit 14 generates, for each of the groups provided by the waveform classifying unit 13, a waveform condition Wp corresponding the group from the waveforms of the one or more pieces of learning outlier data OD_{G,n,ts-te} classified into the same group by the waveform classifying unit 13. The waveform condition generation processing unit 14 outputs the generated waveform condition Wp to the waveform condition storing unit 15.

The waveform condition storing unit 15 is achieved by, for example, a waveform condition storing circuit 32 illustrated in FIG. 2.

The waveform condition storing unit 15 stores the waveform condition Wp generated by the waveform condition generation processing unit 14.

The detection result outputting unit 16 is achieved by, for example, a detection result outputting circuit 33 illustrated in FIG. 2.

The detection result outputting unit 16 displays the determination result output from the abnormality determination processing unit 11 on, for example, a display (not illustrated).

In FIG. 1, it is assumed that each of the learning data inputting unit 1, the abnormality detection data inputting unit 2, the outlier score calculating unit 3, the threshold calculating unit 5, the threshold storing unit 6, the outlier data extraction processing unit 7, the type determining unit 9, the waveform condition selecting unit 10, the abnormality determination processing unit 11, the waveform classifying unit 13, the waveform condition generation processing unit 14, the waveform condition storing unit 15, and the detection result outputting unit 16, which are constituent elements of the abnormality detection device, is achieved by dedicated hardware as illustrated in FIG. 2. That is, it is assumed that the abnormality detection device is achieved by the input interface circuit 21, the input interface circuit 22, the outlier score calculating circuit 23, the threshold calculating circuit 24, the threshold storing circuit 25, the outlier data extraction processing circuit 26, the type determining circuit 27, the waveform condition selecting circuit 28, the abnormality determination processing circuit 29, the waveform classifying circuit 30, the waveform condition generation processing circuit 31, the waveform condition storing circuit 32, and the detection result outputting circuit 33.

Here, for example, to each of the threshold storing circuit 25 and the waveform condition storing circuit 32, a nonvolatile or volatile semiconductor memory such as random access memory (RAM), read only memory (ROM), flash memory, erasable programmable read only memory (EPROM), or electrically erasable programmable read only memory (EEPROM), a magnetic disk, a flexible disk, an optical disc, a compact disc, a mini disc, or a digital versatile disc (DVD) is applicable.

For example, to each of the input interface circuit 21, the input interface circuit 22, the outlier score calculating circuit 23, the threshold calculating circuit 24, the outlier data extraction processing circuit 26, the type determining circuit 27, the waveform condition selecting circuit 28, the abnormality determination processing circuit 29, the waveform classifying circuit 30, the waveform condition generation processing circuit 31, and the detection result outputting circuit 33, a single circuit, a composite circuit, a programmed processor, a parallel programmed processor, an application specific integrated circuit (ASIC), a field-programmable gate array (FPGA), or a combination thereof is applicable.

The constituent elements of the abnormality detection device are not limited to those achieved by dedicated hardware, and the abnormality detection device may be achieved by software, firmware, or a combination of software and firmware.

The software or the firmware is stored as a program in a memory of a computer. The computer means hardware for executing a program. For example, to the computer, a central processing unit (CPU), a central processing device, a processing device, an arithmetic device, a microprocessor, a microcomputer, a processor, or a digital signal processor (DSP) is applicable.

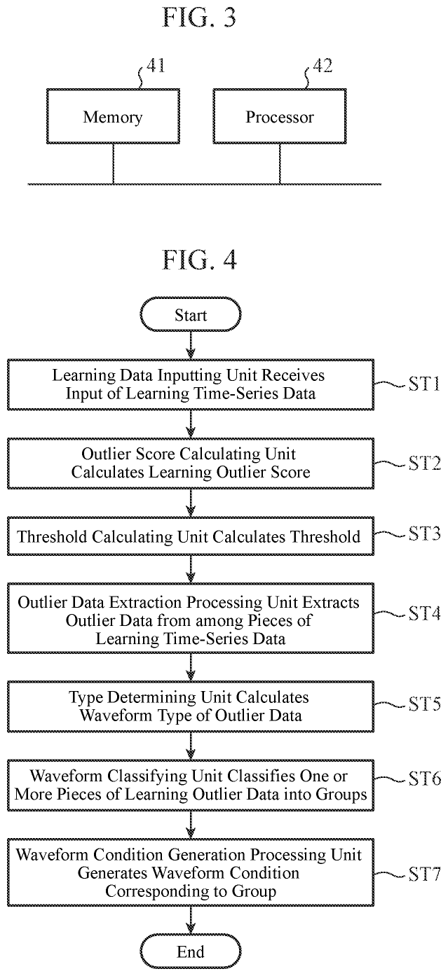

FIG. 3 is a hardware configuration diagram of a computer when the abnormality detection device is achieved by software, firmware, or the like.

When the abnormality detection device is achieved by software, firmware, or the like, the threshold storing unit 6 and the waveform condition storing unit 15 are configured on a memory 41 of a computer. A program for causing the computer to execute a processing procedure performed in the learning data inputting unit 1, the abnormality detection data inputting unit 2, the outlier score calculating unit 3, the threshold calculating unit 5, the outlier data extraction processing unit 7, the type determining unit 9, the waveform condition selecting unit 10, the abnormality determination processing unit 11, the waveform classifying unit 13, the waveform condition generation processing unit 14, and the detection result outputting unit 16 is stored in the memory 41. A processor 42 of the computer executes the program stored in the memory 41.

FIG. 4 is a flowchart illustrating a processing procedure during learning in the abnormality detection device.

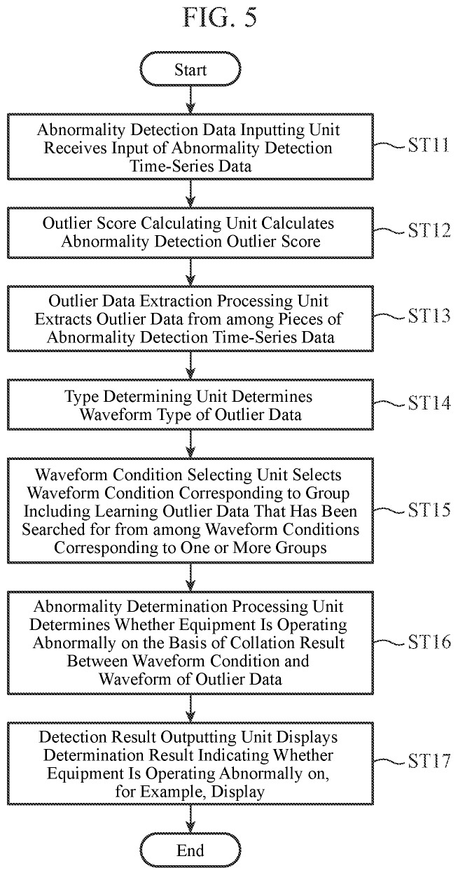

FIG. 5 is a flowchart illustrating an abnormality detection method which is a processing procedure during abnormality detection in the abnormality detection device.

FIG. 2 illustrates an example in which each of the constituent elements of the abnormality detection device is achieved by dedicated hardware, and FIG. 3 illustrates an example in which the abnormality detection device is achieved by software, firmware, or the like. However, this is only an example, and some constituent elements in the abnormality detection device may be achieved by dedicated hardware, and the remaining constituent elements may be achieved by software, firmware, or the like.

Next, an operation of the abnormality detection device illustrated in FIG. 1 will be described.

First, an operation during learning in the abnormality detection device will be described.

First, the learning data inputting unit 1 receives input of N pieces of learning time-series data D_{G,n,t} (n=1, 2, . . . , N) indicating states of equipment which is an abnormality detection target at a plurality of times tin time series when the equipment is operating normally (step ST1 in FIG. 4).

The learning data inputting unit 1 outputs the received learning time-series data D_{G,n,t} to each of the outlier score calculating unit 3 and the outlier data extracting unit 4.

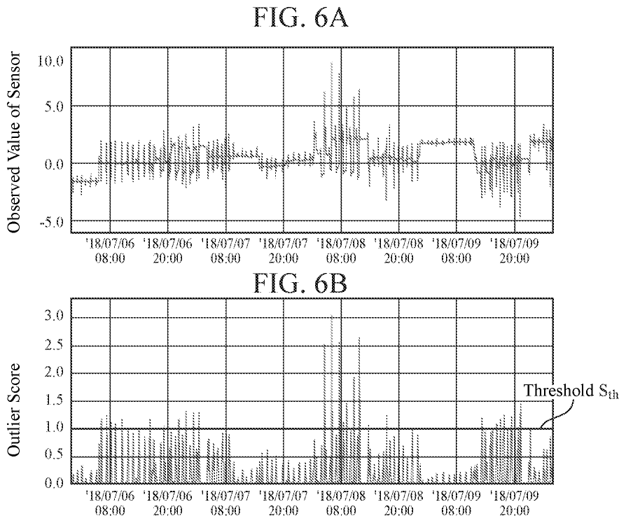

FIG. 6A is an explanatory diagram illustrating an example of the learning time-series data D_{G,n,t}. In FIG. 6A, the horizontal axis indicates time, and the vertical axis indicates an observed value of a sensor included in the learning time-series data D_{G,n,t}.

In FIG. 6A, in order to simplify the drawing, the observed values of the sensor included in the learning time-series data D_{G,n,t} are illustrated as continuous values, but the observed values of the sensor are discrete values.

When receiving N pieces of learning time-series data D_{G,n,t} from the learning data inputting unit 1, the outlier score calculating unit 3 calculates the degree of abnormality of the equipment at each time t as a learning outlier score S_{G,n,t} from each of the N pieces of learning time-series data D_{G,n,t} (step ST2 in FIG. 4).

FIG. 6B is an explanatory diagram illustrating examples of the learning outlier score S_{G,n,t} and the threshold Sₜₕ. In FIG. 6B, the horizontal axis indicates time, and the vertical axis indicates the learning outlier score S_{G,n,t}.

A known technique is applied to a process for calculating the learning outlier score S_{G,n,t}. For example, the following Non-Patent Literature 1 discloses a process for calculating an outlier score. The “Matrix Profile” disclosed in Non-Patent Literature 1 corresponds to an outlier score.

Non-Patent Literature 1:

Chin-Chia Michael Yeh, Yan Zhu, Liudmila Ulanova, Nurjahan Begum, Yifei Ding, Hoang Anh Dau, Diego Furtado Silva, Abdullah Mueen, Eamonn Keogh (2016). Matrix Profile I: All Pairs Similarity Joins for Time Series: A Unifying View that Includes Motifs, Discords and Shapelets.

In the abnormality detection device illustrated in FIG. 1, the outlier score calculating unit 3 calculates the learning outlier score S_{G,n,t} by using the process for calculating an outlier score disclosed in Non-Patent Literature 1.

However, this is only an example, and for example, the outlier score calculating unit 3 may calculate a residual between an observed value of a sensor at each time t included in the learning time-series data D_{G,n,t} and a predicted value at time t as the learning outlier score S_{G,n,t}.

The outlier score calculating unit 3 outputs the calculated learning outlier score S_{G,n,t} at each time t to each of the threshold calculating unit 5 and the outlier data extraction processing unit 7.

The threshold calculating unit 5 calculates the threshold Sₜₕ as illustrated in FIG. 6B from the learning outlier score S_{G,n,t} at each time t calculated by the outlier score calculating unit 3 (step ST3 in FIG. 4).

The threshold calculating unit 5 outputs the calculated threshold Sₜₕ to the threshold storing unit 6.

The threshold storing unit 6 stores the threshold Sₜₕ output from the threshold calculating unit 5.

Hereinafter, an example of a process for calculating the threshold Sₜh by the threshold calculating unit 5 will be described.

First, the threshold calculating unit 5 calculates a mean value S_{G,ave} of all the learning outlier scores S_{G,n,t} calculated from the respective N pieces of learning time-series data D_{G,n,t} by the outlier score calculating unit 3.

In addition, the threshold calculating unit 5 calculates a standard deviation a of all the learning outlier scores S_{G,n,t} calculated from the respective N pieces of learning time-series data D_{G,n,t} by the outlier score calculating unit 3.

Next, the threshold calculating unit 5 calculates the threshold Sₜₕ from the mean value S_{G,ave} and the standard deviation σ as illustrated in the following formula (1).

Sₜₕ=S_{G,ave}+3σ (1)

In the abnormality detection device illustrated in FIG. 1, the threshold calculating unit 5 calculates the threshold Sₜₕ on the assumption that a threshold used during learning and a threshold used during abnormality detection are the same threshold.

However, this is only an example, and the threshold calculating unit 5 may separately calculate the threshold Sₜₕ used during learning and the threshold Sₜₕ used during abnormality detection.

As the threshold Sₜₕ used during learning, for example, a threshold in a range of (S_{G,ave}+σ) to (S_{G,ave}+2σ) is calculated as a threshold less than the threshold Sₜₕ illustrated in formula (1) in such a manner that the outlier data extraction processing unit 7 can extract many pieces of learning outlier data OD_{G,n,ts-te}.

As the threshold Sₜₕ used during abnormality detection, for example, the threshold Sₜₕ illustrated in formula (1) is calculated.

The outlier data extraction processing unit 7 acquires the learning outlier score S_{G,n,t} calculated by the outlier score calculating unit 3 at each time t and acquires the threshold Sₜₕ stored by the threshold storing unit 6.

The outlier data extraction processing unit 7 compares the learning outlier score S_{G,n,t} at each time t with the threshold Sₜₕ.

The outlier data extraction processing unit 7 detects a period ts-te in which a learning outlier score S_{G,n,t} is equal to or more than the threshold Sₜₕ by specifying a learning outlier score S_{G,n,t} equal to or more than the threshold Sₜₕ among the learning outlier scores S_{G,n,t} at respective times t on the basis of a comparison result between the learning outlier score S_{G,n,t} and the threshold Sₜₕ.

The outlier data extraction processing unit 7 extracts learning time-series data D_{G,n,ts} to D_{G,n,te} in the detection period ts-te as learning outlier data OD_{G,n,ts-te} from among pieces of learning time-series data D_{G,n,t} (step ST4 in FIG. 4).

The outlier data extraction processing unit 7 outputs the extracted learning outlier data OD_{G,n,ts-te} to each of the type determining unit 9, the waveform condition selecting unit 10, the waveform classifying unit 13, and the waveform condition generation processing unit 14.

When receiving the learning outlier data OD_{G,n,ts-te} from the outlier data extraction processing unit 7, the type determining unit 9 calculates a feature amount C_{G,n} of the learning outlier data OD_{G,n,ts-te}, and determines the waveform type of the learning outlier data OD_{G,n,ts-te} from the feature amount C_{G,n} (step ST5 in FIG. 4).

The type determining unit 9 outputs the determined waveform type of the learning outlier data OD_{G,n,ts-te} to the waveform classifying unit 13.

Hereinafter, a process for determining a waveform type by the type determining unit 9 will be specifically described.

Here, an example in which the type determining unit 9 classifies the waveforms of pieces of learning outlier data OD_{G,n,ts-te} into six groups of an upper peak type waveform, a lower peak type waveform, an upper and lower peak type waveform, a transient ascending type waveform, a transient descending type waveform, and a vibration type waveform will be described.

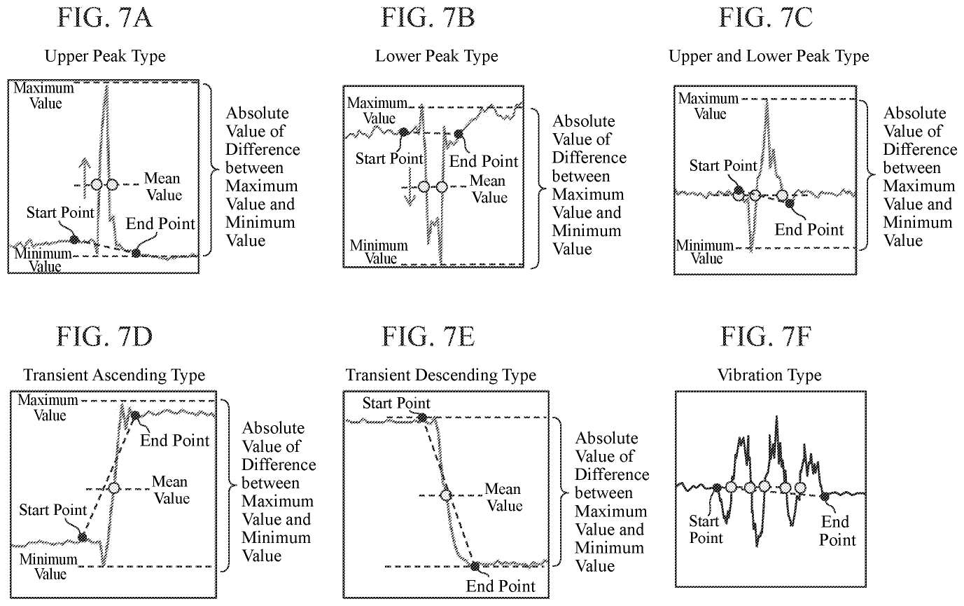

FIG. 7 is an explanatory diagram illustrating waveforms of learning outlier data OD_{G,n,ts-te} when the waveform type is an “upper peak type”, a “lower peak type”, an “upper and lower peak type”, a “transient ascending type”, a “transient descending type”, or a “vibration type”.

In FIG. 7, the start point is a point where the waveform of the learning outlier data OD_{G,n,ts-te} starts, and the end point is a point where the waveform of the learning outlier data OD_{G,n,ts-te} ends.

[Upper Peak Type]

In the upper peak type waveform, as illustrated in FIG. 7A, a value of the learning outlier data OD_{G,n,ts-te} rises sharply, then falls sharply, and then returns to the vicinity of the value observed before the value of the learning outlier data OD_{G,n,ts-te} rises sharply.

[Lower Peak Type]

In the lower peak type waveform, as illustrated in FIG. 7B, a value of the learning outlier data OD_{G,n,ts-te} falls sharply, then rises sharply, and then returns to the vicinity of the value observed before the value of the learning outlier data OD_{G,n,ts-te} falls sharply.

[Upper and Lower Peak Type]

In the upper and lower peak type waveform, as illustrated in FIG. 7C, a value of the learning outlier data OD_{G,n,ts-te} falls sharply to a minimum value, then rises sharply to a maximum value, and then returns to the vicinity of the value observed before the value of the learning outlier data OD_{G,n,ts-te} falls sharply.

In addition, in the upper and lower peak type waveforms, a value of the learning outlier data OD_{G,n,ts-te} rises sharply to a maximum value, then falls sharply to a minimum value, and then returns to the vicinity of the value observed before the value of the learning outlier data OD_{G,n,ts-te} rises sharply.

[Transient Ascending Type]

In the transient ascending type waveform, as illustrated in FIG. 7D, a value of the learning outlier data OD_{G,n,ts-te} rises to a maximum value, and then becomes a value in the vicinity of the maximum value.

[Transient Descending Type Waveform]

In the transient descending type waveform, as illustrated in FIG. 7E, a value of the learning outlier data OD_{G,n,ts-te} falls to a minimum value, and then becomes a value in the vicinity of the minimum value.

[Vibration Type Waveform]

In the vibration type waveform, as illustrated in FIG. 7F, a value of the learning outlier data OD_{G,n,ts-te} continues to oscillate up and down and does not converge.

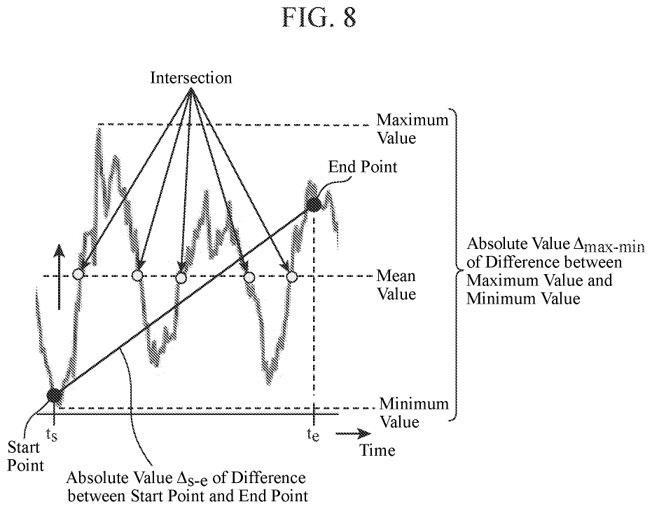

FIG. 8 is an explanatory diagram illustrating an example of a feature amount C_{G,n} in the learning outlier data OD_{G,n,ts-te}.

First, the type determining unit 9 calculates a mean value D_{G,n,ave} of the pieces of learning outlier data OD_{G,n,ts-te} output from the outlier data extraction processing unit 7.

The type determining unit 9 counts the number of intersections CN, which is the number of times the learning outlier data OD_{G,n,ts-te} intersects with the mean value D_{G,n,ave}, as one of the feature amounts C_{G, n}.

The learning outlier data OD_{G,n,ts-te} illustrated in FIG. 8 intersects with the mean value D_{G,n,ave} five times.

The type determining unit 9 focuses on the first intersection counting from the start point of the learning outlier data OD_{G,n,ts-te} among one or more intersections where the learning outlier data OD_{G,n,ts-te} intersects with the mean value D_{G,n,ave}.

When the learning outlier data OD_{G,n,ts-te} changes from a value lower than the mean value D_{G,n,ave} to a value higher than the mean value D_{G,n,ave} after the first intersection, the type determining unit 9 takes “first intersection=positive” as one of the feature amounts C_{G,n}.

When the learning outlier data OD_{G,n,ts-te} changes from a value higher than the mean value D_{G,n,ave} to a value lower than the mean value D_{G,n,ave} after the first intersection, the type determining unit 9 takes “first intersection=negative” as one of the feature amounts C_{G,n}.

In the learning outlier data OD_{G,n,ts-te} illustrated in FIG. 8, the first intersection is positive.

In addition, the type determining unit 9 calculates, as one of the feature amounts C_{G,n}, an absolute value Δₛ₋ₑ of a difference between the start point of the learning outlier data OD_{G,n,ts-te} and the end point of the learning outlier data OD_{G,n,ts-te}.

Furthermore, the type determining unit 9 calculates, as one of the feature amounts C_{G,n}, an absolute value Δₘₐₓ₋ₘᵢₙ of a difference between a maximum value out of pieces of learning outlier data OD_{G,n,ts-te} and a minimum value out of pieces of learning outlier data OD_{G,n,ts-te}.

When the number of intersections CN is 2 and “first intersection=positive”, the type determining unit 9 determines that the waveform type is “upper peak type”.

When the number of intersections CN is 1, “first intersection=positive”, and Δₛ₋ₑ≤Δₘₐₓ₋ₘᵢₙ×α, the type determining unit 9 determines that the waveform type is “upper peak type”. Provided that α is an arbitrary constant, and 0≤α≤1. The constant α may be stored in an internal memory of the type determining unit 9 or may be given from the outside.

When the number of intersections CN is 2 and “first intersection=negative”, the type determining unit 9 determines that the waveform type is “lower peak type”.

When the number of intersections CN is 1, “first intersection=negative”, and Δₛ₋ₑ≤Δₘₐₓ₋ₘᵢₙ×α, the type determining unit 9 determines that the waveform type is “lower peak type”.

When the number of intersections CN is 3 and Δₛ₋ₑ≤Δₘₐₓ₋ₘᵢₙ×β, the type determining unit 9 determines that the waveform type is “upper and lower peak type”. Provided that β is an arbitrary constant, and 0≤β≤1. The constant β may be stored in an internal memory of the type determining unit 9 or may be given from the outside.

When the number of intersections CN is 1, “first intersection=positive”, and Δₛ₋ₑ>Δₘₐₓ₋ₘᵢₙ×α, the type determining unit 9 determines that the waveform type is “transient ascending type”.

When the number of intersections CN is 1, “first intersection=negative”, and Δₛ₋ₑ>Δₘₐₓ₋ₘᵢₙ×α, the type determining unit 9 determines that the waveform type is “transient descending type”.

When the number of intersections CN is 4 or more, the type determining unit 9 determines that the waveform type is “vibration type”.

When the number of intersections CN is 3 and Δₛ₋ₑ>Δₘₐₓ₋ₘᵢₙ×α, the type determining unit 9 determines that the waveform type is “vibration type”.

The waveform classifying unit 13 classifies one or more pieces of learning outlier data OD_{G,n,ts-te} whose waveforms have been determined to be of the same type by the type determining unit 9 out of the pieces of learning outlier data OD_{G,n,ts-te} extracted by the outlier data extracting unit 4 into groups.

Next, the waveform classifying unit 13 calculates, for each of the provided groups, the degree of similarity between one or more pieces of learning outlier data OD_{G,n,ts-te} included in the group.

As the degree of similarity between one or more pieces of learning outlier data OD_{G,n,ts-te}, a distance between the waveforms of one or more pieces of learning outlier data OD_{G,n,ts-te} may be calculated. As the distance to be calculated, a Euclidean distance, a 1-correlation coefficient, a Manhattan distance, a dynamic time warping (DTW) distance, and the like are conceivable. The shorter the distance, the higher the degree of similarity.

Since a process itself for calculating a distance between the waveforms of one or more pieces of learning outlier data OD_{G,n,ts-te} is a known technique, detailed description thereof is omitted.

The waveform classifying unit 13 further classifies one or more pieces of learning outlier data OD_{G,n,ts-te} classified into the same group into groups on the basis of the calculated degree of similarity (step ST6 in FIG. 4).

Specifically, the waveform classifying unit 13 performs clustering of learning outlier data OD_{G,n,ts-te} in such a manner that pieces of learning outlier data OD_{G,n,ts-te} having the calculated high degree of similarity to each other are included in the same group among one or more pieces of learning outlier data OD_{G,n,ts-te} classified into the same group. The waveform classifying unit 13 determines, for example, that pieces of learning outlier data OD_{G,n,ts-te} having the calculated degree of similarity higher than or equal to a threshold are pieces of learning outlier data OD_{G,n,ts-te} having a high degree of similarity to each other.

As a clustering method, a k-means method can be used. However, the clustering method is not limited to the k-means method, and spectral clustering, hierarchical clustering, or the like may be used.

The threshold to be compared with the calculated degree of similarity may be stored in an internal memory of the type determining unit 9 or may be given from the outside.

The waveform classifying unit 13 outputs a classification result of one or more pieces of learning outlier data OD_{G,n,ts-te} to the waveform condition generation processing unit 14.

The waveform condition generation processing unit 14 generates, for each of the groups provided by the waveform classifying unit 13, a waveform condition Wp corresponding to the group from the waveforms of the one or more pieces of learning outlier data OD_{G,n,ts-te} included in the group (step ST7 in FIG. 4).

The waveform condition generation processing unit 14 generates, for example, a band model indicating a normal range of a waveform as the waveform condition Wp.

The waveform condition generation processing unit 14 outputs the generated waveform condition Wp to the waveform condition storing unit 15.

The waveform condition storing unit 15 stores the waveform condition Wp output from the waveform condition generation processing unit 14.

Hereinafter, a process for generating a band model by the waveform condition generation processing unit 14 will be specifically described.

Here, for convenience of explanation, it is assumed that one or more pieces of learning outlier data OD_{G,n,ts-te} included in one group are represented by P₁, P₂, . . . , Pₘ. It is assumed that a value of Pᵢ at time t is represented by Pᵢ[t]. i=1, 2, . . . , m. The time t is any time in the period ts-te, and specifically, the time t is any time when the time ts is replaced with 1 (t=1, 2, . . . , (te-ts)).

The waveform condition generation processing unit 14 calculates a mean value Pₘₑₐₙ[t] of m pieces of Pᵢ[t] at time t as illustrated in the following formula (2), and calculates a standard deviation P_{std}[t] of m pieces of Pᵢ[t] at time t as illustrated in the following formula (3).

$$\begin{matrix}{P}_{mean} [ t ] = \frac{{P}_{1} [ t ] + {P}_{2} [ t ] + … + {P}_{m} [ t ]}{m} & ( 2 ) \\ Pstd [ t ] = \sqrt{\frac{{( {P}_{1} [ t ] - {P}_{mean} [ t ] )}^{2} + … + {( {P}_{m} [ t ] - {P}_{mean} [ t ] )}^{2}}{m}} & ( 3 )\end{matrix}$$

The waveform condition generation processing unit 14 calculates an upper limit value Bᵤₚₚₑᵣ[t] of a normal range indicated by a band model by using the mean value Pₘₑₐₙ[t], the standard deviation P_{std}[t], and a constant λ (1≤λ) as illustrated in the following formula (4). The constant λ may be stored in an internal memory of the waveform condition generation processing unit 14 or may be given from the outside.

Bᵤₚₚₑᵣ[t]=Pₘₑₐₙ[t]+P_{std}[t]×λ (4)

The waveform condition generation processing unit 14 calculates a lower limit value B_{lower}[t] of a normal range indicated by a band model by using the mean value Pₘₑₐₙ[t], the standard deviation P_{std}[t], and a constant λ (1≤λ) as illustrated in the following formula (5).

B_{lower}[t]=Pₘₑₐₙ[t]−P_{std}[t]×λ (5)

Here, the waveform condition generation processing unit 14 calculates the upper limit value Bᵤₚₚₑᵣ[t] and the lower limit value B_{lower}[t] of a normal range indicated by a band model by using the mean value Pₘₑₐₙ[t] and the standard deviation P_{std}[t]. However, this is only an example, and the waveform condition generation processing unit 14 may calculate the upper limit value Bᵤₚₚₑᵣ[t] and the lower limit value B_{lower}[t] of a normal range indicated by a band model by using a maximum value Pₘₐₓ[t] and a minimum value Pₘᵢₙ[t] out of m pieces of Pᵢ[t] at time t.

The waveform condition generation processing unit 14 determines the maximum value Pₘₐₓ[t] out of m pieces of Pᵢ[t] at time t as illustrated in the following formula (6), and determines the minimum value Pₘᵢₙ[t] out of m pieces of m Pᵢ[t] at time t as illustrated in the following formula (7).

Pₘₐₓ[t]=max(P₁[t],P₂[t], . . . ,Pₘ[t]) (6)

Pₘᵢₙ[t]=min(P₁[t],P₂[t], . . . ,Pₘ[t]) (7)

The waveform condition generation processing unit 14 calculates the upper limit value Bᵤₚₚₑᵣ[t] of a normal range indicated by a band model by using the maximum value Pₘₐₓ[t], the minimum value Pₘᵢₙ[t], and a constant δ (1≤δ≤m) as illustrated in the following formula (8).

$${B}_{upper} [ t ] = max ( {P}_{max} [ t - \frac{δ}{2} : t + \frac{δ}{2} ] ) \qquad ( 8 )$$

In formula (8), Pₘₐₓ[t−δ/2: t+δ/2] is a maximum value Pₘₐₓ[t] at each time t included in time (t−δ/2) to time (t+δ/2).

The waveform condition generation processing unit 14 calculates the lower limit value B_{lower}[t] of a normal range indicated by a band model by using the maximum value Pₘₐₓ[t], the minimum value Pₘᵢₙ[t], and a constant δ (1≤δ≤m) as illustrated in the following formula (9).

$${B}_{lower} [ t ] = min ( {P}_{min} [ t - \frac{δ}{2} : t + \frac{δ}{2} ] ) \qquad ( 9 )$$

In formula (9), Pₘᵢₙ[t−δ/2: t+δ/2] is a minimum value Pₘᵢₙ[t] at each time t included in time (t−δ/2) to time (t+δ/2).

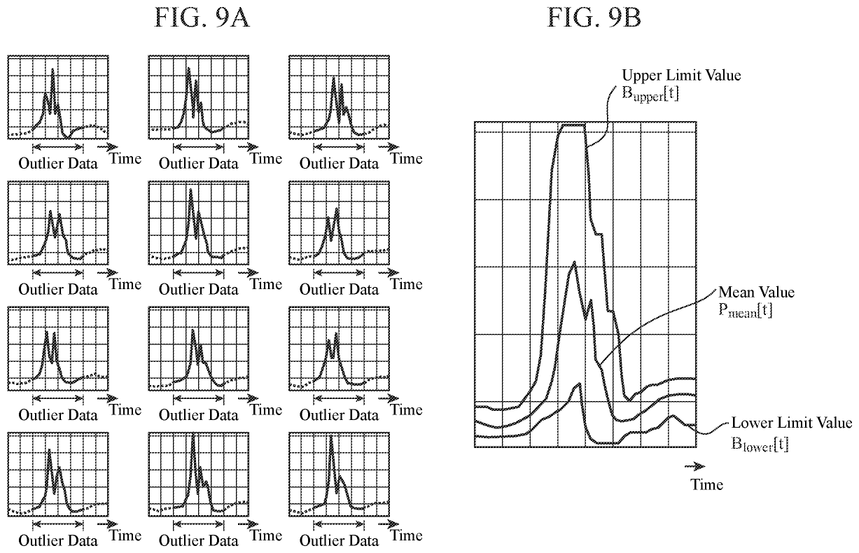

FIG. 9 is an explanatory diagram illustrating an example of generating a band model having a waveform type of “upper peak type”.

FIG. 9A illustrates N (N=12) pieces of learning outlier data OD_{G,n,ts-te} having a waveform type of “upper peak type”.

In FIG. 9A, the horizontal axis indicates time t, and the vertical axis indicates a value Pᵢ[t] of the learning outlier data OD_{G,n,ts-te} at time t.

The solid line part indicates learning outlier data OD_{G,n,ts-te}, and the broken line part indicates learning time-series data D_{G,n,t} before and after the learning outlier data OD_{G,n,ts-te}.

FIG. 9B illustrates a mean value Pₘₑₐₙ[t] of N pieces of learning outlier data OD_{G,n,ts-te}, and an upper limit value Bᵤₚₚₑᵣ[t] and a lower limit value B_{lower}[t] of a normal range indicated by a band model.

In FIG. 9B, the horizontal axis indicates time t, and the vertical axis indicates a mean value Pₘₑₐₙ[t] at time t, an upper limit value Bᵤₚₚₑᵣ[t] at time t, and a lower limit value B_{lower}[t] at time t.

In the example of FIG. 9, the waveform condition generation processing unit 14 generates a band model having a waveform type of “upper peak type” from 12 pieces of learning outlier data OD_{G,n,ts-te}.

Next, an operation during abnormality detection in the abnormality detection device will be described.

First, the abnormality detection data inputting unit 2 receives input of abnormality detection time-series data D_{U,t} indicating states of equipment which is an abnormality detection target at a plurality of times tin time series (step ST11 in FIG. 5).

The abnormality detection data inputting unit 2 outputs the received abnormality detection time-series data D_{U,t} to each of the outlier score calculating unit 3 and the outlier data extraction processing unit 7.

When receiving the abnormality detection time-series data D_{U,t} output from the abnormality detection data inputting unit 2, the outlier score calculating unit 3 calculates an abnormality detection outlier score S_{U,t} at each time t from the abnormality detection time-series data D_{U,t} (step ST12 in FIG. 5).

A process for calculating the abnormality detection outlier score S_{U,t} is similar to the process for calculating a learning outlier score S_{G,n,t}.

The outlier score calculating unit 3 outputs the calculated abnormality detection outlier score S_{U,t} at each time t to the outlier data extraction processing unit 7.

The outlier data extraction processing unit 7 acquires the abnormality detection outlier score S_{U,t} calculated by the outlier score calculating unit 3 at each time t and acquires the threshold Sₜₕ stored by the threshold storing unit 6.

The outlier data extraction processing unit 7 compares the abnormality detection outlier score S_{U,t} at each time t with the threshold Sₜₕ.

The outlier data extraction processing unit 7 detects a period ts′-te′ in which an abnormality detection outlier score S_{U,t} is equal to or more than the threshold Sₜₕ by specifying an abnormality detection outlier score S_{U,t} equal to or more than the threshold Sₜₕ among the abnormality detection outlier scores S_{U,t} at respective times t on the basis of a comparison result between the abnormality detection outlier score S_{U,t} and the threshold Sₜₕ.

The outlier data extraction processing unit 7 extracts abnormality detection time-series data D_{U,ts′} to D_{U,te′} in the detection period ts′-te′ as abnormality detection outlier data OD_{U,ts′-te′} from among pieces of abnormality detection time-series data D_{U,t} (step ST13 in FIG. 5).

The outlier data extraction processing unit 7 outputs the extracted abnormality detection outlier data OD_{U,ts′-te′} to each of the type determining unit 9, the waveform condition selecting unit 10, and the abnormality determination processing unit 11.

In the abnormality detection device illustrated in FIG. 1, in order to simplify explanation, the following description will be given by assuming that the outlier data extraction processing unit 7 extracts one piece of abnormality detection outlier data OD_{U,ts′-te′} from among pieces of abnormality detection time-series data D_{U,t}.

When receiving the abnormality detection outlier data OD_{U,ts′-te′} from the outlier data extraction processing unit 7, the type determining unit 9 calculates a feature amount Cu of the abnormality detection outlier data OD_{U,ts′-te′}.

A process for calculating the feature amount Cu in the abnormality detection outlier data OD_{U,ts′-te′} is similar to the process for calculating a feature amount C_{G,n} in the learning outlier data OD_{G,n,ts-te}.

The type determining unit 9 determines the waveform type of the abnormality detection outlier data OD_{U,ts′-te′} from the feature amount Cu of the abnormality detection outlier data OD_{U,ts′-te′} (step ST14 in FIG. 5).

A process for determining the waveform type of the abnormality detection outlier data OD_{U,ts′-te′} is similar to the process for determining the waveform type of the learning outlier data OD_{G,n,ts-te}.

The type determining unit 9 outputs the determined waveform type to the waveform condition selecting unit 10.

The waveform condition selecting unit 10 calculates the degree of similarity between the abnormality detection outlier data OD_{U,ts′-te′} output from the outlier data extraction processing unit 7 and each of N pieces of learning outlier data OD_{G,n,ts-te} output from the outlier data extraction processing unit 7.

As the degree of similarity between the abnormality detection outlier data OD_{U,ts′-te′} and the learning outlier data OD_{G,n,ts-te}, a distance between the waveform of abnormality detection outlier data OD_{U,ts′-te′} and the waveform of the learning outlier data OD_{G,n,ts-te} may be calculated. As the distance to be calculated, a Euclidean distance, a 1-correlation coefficient, a Manhattan distance, a DTW distance, and the like are conceivable. Since a process itself for calculating the distance is a known technique, detailed description thereof is omitted.

The waveform condition selecting unit 10 searches for a piece of learning outlier data OD_{G,n,ts-te} having the highest degree of similarity to the abnormality detection outlier data OD_{U,ts′-te′} among N pieces of learning outlier data OD_{G,n,ts-te}. The waveform type of the piece of learning outlier data OD_{G,n,ts-te} having the highest degree of similarity to the abnormality detection outlier data OD_{U,ts′-te′} is the same as the waveform type of the abnormality detection outlier data OD_{U,ts′-te′}.

The waveform condition selecting unit 10 selects a waveform condition Wp corresponding to a group including the piece of learning outlier data OD_{G,n,ts-te} that has been searched for from among waveform conditions Wp corresponding to the one or more groups stored by the waveform condition storing unit 15 (step ST15 in FIG. 5).

The waveform condition selecting unit 10 outputs the selected waveform condition Wp to the abnormality determination processing unit 11.

The abnormality determination processing unit 11 collates the waveform condition Wp selected by the waveform condition selecting unit 10 with the waveform of the abnormality detection outlier data OD_{U,ts′-te′} extracted by the outlier data extraction processing unit 7.

The abnormality determination processing unit 11 determines whether or not the equipment is operating abnormally on the basis of a collation result between the waveform condition Wp and the waveform of abnormality detection outlier data OD_{U,ts′-te′} (step ST16 in FIG. 5).

The abnormality determination processing unit 11 outputs a determination result indicating whether or not the equipment is operating abnormally to the detection result outputting unit 16.

The detection result outputting unit 16 displays the determination result output from the abnormality determination processing unit 11 on, for example, a display (not illustrated) (step ST17 in FIG. 5).

Hereinafter, a process for determining abnormality of equipment by the abnormality determination processing unit 11 will be specifically described.

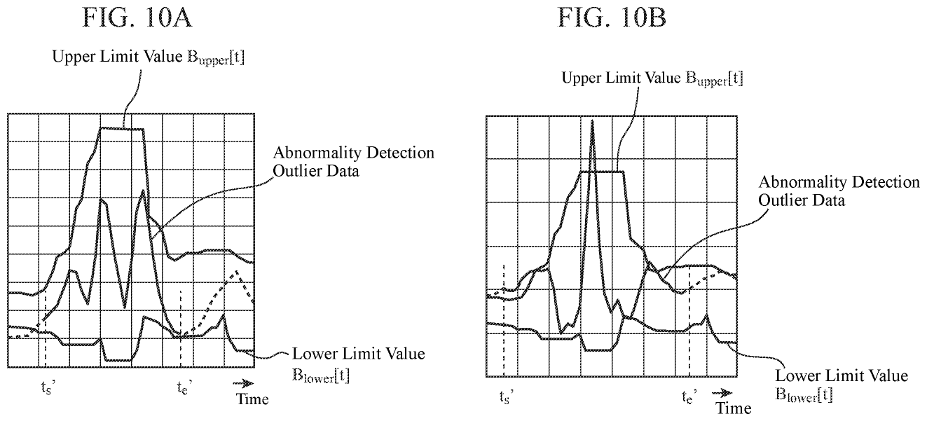

FIG. 10A is an explanatory diagram illustrating a waveform of abnormality detection outlier data OD_{U,ts′-te′} when the abnormality determination processing unit 11 determines that equipment is operating normally.

FIG. 10B is an explanatory diagram illustrating a waveform of abnormality detection outlier data OD_{U,ts′-te′} when the abnormality determination processing unit 11 determines that equipment is operating abnormally.

In FIGS. 10A and 10B, the horizontal axis indicates time t. The vertical axis indicates a value of abnormality detection outlier data OD_{U,ts′-te′} at time t, and an upper limit value Bᵤₚₚₑᵣ[t] and a lower limit value B_{lower}[t] of a normal range indicated by a bandpass at time t.

When the waveform of abnormality detection outlier data OD_{U,ts′-te′} is equal to or more than the lower limit value B_{lower}[t] of the bandpass and equal to or less than the upper limit value Bᵤₚₚₑᵣ[t] of the bandpass over the entire period ts′-te′, the abnormality determination processing unit 11 determines that the equipment is operating normally because the waveform is included in the normal range.

The waveform of abnormality detection outlier data OD_{U,ts′-te′} illustrated in FIG. 10A is equal to or more than the lower limit value B_{lower}[t] and equal to or less than the upper limit value Bᵤₚₚₑᵣ[t] over the entire period ts′-te′. Therefore, the abnormality determination processing unit 11 determines that the equipment is operating normally.

When the waveform of abnormality detection outlier data OD_{U,ts′-te′} is less than the lower limit value B_{lower}[t] at any time tin the period ts′-te′, or more than the upper limit value Bᵤₚₚₑᵣ[t] at any time t, the abnormality determination processing unit 11 determines that the equipment is operating abnormally because the waveform deviates from the normal range.

The waveform of abnormality detection outlier data OD_{U,ts′-te′} illustrated in FIG. 10B is more than the upper limit value Bᵤₚₚₑᵣ[t] three times. Therefore, the abnormality determination processing unit 11 determines that the equipment is operating abnormally.

Here, when the waveform of abnormality detection outlier data OD_{U,ts′-te′} is equal to or more than the lower limit value B_{lower}[t] and equal to or less than the upper limit value Bᵤₚₚₑᵣ[t] over the entire period ts′-te′, the abnormality determination processing unit 11 determines that the equipment is operating normally. However, this is only an example. Even when the waveform of abnormality detection outlier data OD_{U,ts′-te′} deviates from the normal range indicated by the band model, the abnormality determination processing unit 11 may determine that the equipment is operating normally as long as the outlier is within an allowable range.

This will be specifically described as follows.

The abnormality determination processing unit 11 prepares a variable K having an initial value of 0.

When a value of abnormality detection outlier data OD_{U,ts′-te′} is more than the upper limit value Bᵤₚₚₑᵣ[t] at each time tin the period ts′-te′, the abnormality determination processing unit 11 adds “1” to the variable K. Therefore, for example, when there are three times as time t at which a value of abnormality detection outlier data OD_{U,ts′-te′} is more than the upper limit value Bᵤₚₚₑᵣ[t], the abnormality determination processing unit 11 adds “3” to the variable K.

When a value of abnormality detection outlier data OD_{U,ts′-te′} is less than the lower limit value B_{lower}[t] at each time tin the period ts′-te′, the abnormality determination processing unit 11 adds “1” to the variable K. Therefore, for example, when there are two times as time t at which a value of abnormality detection outlier data OD_{U,ts′-te′} is less than the lower limit value B_{lower}[t], the abnormality determination processing unit 11 adds “2” to the variable K.

As illustrated in the following formula (10), when a value obtained by multiplying the period ts′-te′ by a coefficient ζ (0≤ζ<1) is equal to or more than the variable K, the abnormality determination processing unit 11 determines that the equipment is operating normally.

K≤|ts′-te′|×ζ (10)

When the value obtained by multiplying the period ts′-te′ by the coefficient ζ is less than the variable K, the abnormality determination processing unit 11 determines that the equipment is operating abnormally.

Note that the constant ζ may be stored in an internal memory of the abnormality determination processing unit 11 or may be given from the outside. When ζ=0, the allowable range is zero.

Here, as an example in which even when the waveform of abnormality detection outlier data OD_{U,ts′-te′} deviates from the normal range indicated by the band model, the abnormality determination processing unit 11 determines that the equipment is operating normally as long as the outlier is within an allowable range, an example is described in which the abnormality determination processing unit 11 determines that the equipment is operating normally when formula (10) is satisfied.

However, this is only an example, and the following specific examples are also conceivable.

Even when the number of outliers of the waveform of abnormality detection outlier data OD_{U,ts′-te′} from the normal range indicated by the band model is small, the width of each outlier may be large.

Meanwhile, even when the number of outliers of the waveform of abnormality detection outlier data OD_{U,ts′-te′} from the normal range indicated by the band model is large, the width of each outlier may be small.

For example, it is conceivable that possibility that the equipment is operating normally is higher in a case where the number of outliers when the width of outlier is about 1% of the width of the band model is 2 to 3 times than in a case where the number of outliers when the width of outlier is about the same as the width of the band model is one time.

The abnormality determination processing unit 11 prepares a variable G having an initial value of 0.

The abnormality determination processing unit 11 subtracts the upper limit value Bᵤₚₚₑᵣ[t] from a value of abnormality detection outlier data OD_{U,ts′-te′} at each time tin the period ts′-te′, and adds the value obtained by the subtraction to the variable G when the value obtained by the subtraction is positive.

The abnormality determination processing unit 11 subtracts a value of abnormality detection outlier data OD_{U,ts′-te′} from the lower limit value B_{lower}[t] at each time tin the period ts′-te′, and adds the value obtained by the subtraction to the variable G when the value obtained by the subtraction is positive.

The abnormality determination processing unit 11 determines that the equipment is operating normally when the variable G is equal to or less than the threshold Gth, and determines that the equipment is operating abnormally when the variable G is more than the threshold Gth.

The threshold Gth may be stored in an internal memory of the abnormality determination processing unit 11 or may be given from the outside.

As the threshold Gth, such a threshold Gth as illustrated in the following formula (11) or (12) can be used.

Gth=(max(Bᵤₚₚₑᵣ[t])−min(B_{lower}[t]))×θ (11)

In formula (11), max(Bᵤₚₚₑᵣ[t]) represents a maximum value out of the upper limit values Bᵤₚₚₑᵣ[t] in the period ts′-te′, min(B_{lower}[t]) represents a minimum value out of the lower limit values B_{lower}[t] in the period ts′-te′, and θ represents a coefficient equal to or more than 0. The coefficient θ may be stored in an internal memory of the abnormality determination processing unit 11 or may be given from the outside.

$$Gth = \frac{( \begin{matrix}( {B}_{upper} [ {ts}^{′} ] - {B}_{lower} [ {ts}^{′} ] ) + ( {B}_{upper} [ {ts}^{′} + 1 ] - {B}_{lower} [ {ts}^{′} ] + \\ 1 ) + ... + ( {B}_{upper} [ {te}^{′} ] - {B}_{lower} [ {te}^{′} ] )\end{matrix} )}{h} \times θ \qquad ( 12 )$$

In formula (12), h represents the number of times tin the period ts′-te′.

In the abnormality detection device illustrated in FIG. 1, the outlier data extraction processing unit 7 extracts one piece of abnormality detection outlier data OD_{U,ts′-te′} from among pieces of abnormality detection time-series data D_{U,t}.

However, this is only an example, and the outlier data extraction processing unit 7 may extract two or more pieces of abnormality detection outlier data OD_{U,ts′-te′} having different detection periods ts′-te′ from each other from among pieces of abnormality detection time-series data D_{U,t}.

When the outlier data extraction processing unit 7 extracts two or more pieces of abnormality detection outlier data OD_{U,ts′-te′}, the type determining unit 9, the waveform condition selecting unit 10, and the abnormality determination processing unit 11 perform the process described above for each of the pieces of abnormality detection outlier data OD_{U,ts′-te′}.

In the first embodiment described above, the abnormality detection device is configured in such a manner that the abnormality determining unit 8 collates a waveform of the abnormality detection outlier data extracted by the outlier data extracting unit 4 with a waveform condition for determining that a waveform indicating a change in the abnormality detection outlier data is a waveform obtained when equipment is operating normally, and determines whether or not the equipment is operating abnormally on the basis of a collation result between the waveform condition and the waveform of the abnormality detection outlier data. Therefore, the abnormality detection device can avoid occurrence of erroneous determination indicating that an abnormality has occurred in the equipment without preparing event information in advance.

In addition to an event that can be predicted in advance, there is an event that is difficult to predict. Therefore, event information cannot be prepared in advance in some cases.

Meanwhile, in the abnormality detection device illustrated in FIG. 1, it is necessary to prepare a waveform condition Wp in advance instead of preparing event information. Since the waveform condition Wp can be generated from learning time-series data D_{G,n,t} obtained when the equipment is operating normally, it is easy to prepare the waveform condition Wp in advance.

In the abnormality detection device illustrated in FIG. 1, the waveform classifying unit 13 calculates the degree of similarity between one or more pieces of learning outlier data OD_{G,n,ts-te} included in a group.

However, the lengths of the waveforms of one or more pieces of learning outlier data OD_{G,n,ts-te} are not necessarily the same, but may be different.

For example, when the lengths of the waveforms of two pieces of learning outlier data OD_{G,n,ts-te} are different, the waveform classifying unit 13 first aligns the beginning of a waveform having a shorter length with the beginning of a waveform having a longer length, and calculate a distance between the waveform having a shorter length and the waveform having a longer length.

The waveform classifying unit 13 repeatedly calculates a distance between the waveform having a shorter length and the waveform having a longer length while sliding the waveform having a shorter length in parallel to the waveform having a longer length until the end of the waveform having a shorter length coincides with the end of the waveform having a longer length.

The waveform classifying unit 13 selects a minimum distance out of all the calculated distances, and determines the degree of similarity corresponding to the selected distance as the degree of similarity between a piece of learning outlier data OD_{G,n,ts-te} having a longer waveform length and a piece of learning outlier data OD_{G,n,ts-te} having a shorter waveform length. As the degree of similarity corresponding to the distance, for example, an integral multiple of a reciprocal of the distance is conceivable.

When classifying pieces of learning outlier data OD_{G,n,ts-te} having the degree of similarity equal to or higher than the threshold into the same group, the waveform classifying unit 13 specifies a slide position at which the degree of similarity of a piece of learning outlier data OD_{G,n,ts-te} having a shorter waveform length with respect to a piece of learning outlier data OD_{G,n,ts-te} having the longest waveform length is maximum.

The waveform classifying unit 13 disposes the piece of learning outlier data OD_{G,n,ts-te} having a shorter waveform length at the slide position specified with respect to the piece of learning outlier data OD_{G,n,ts-te} having the longest waveform length.

By disposing the piece of learning outlier data OD_{G,n,ts-te} having a shorter waveform length at the specified slide position, the beginning of the piece of learning outlier data OD_{G,n,ts-te} having a shorter waveform length may be located closer to the end than the beginning of the piece of learning outlier data OD_{G,n,ts-te} having the longest waveform length.

By adding a piece of learning time-series data D_{G,n,t} at a time earlier than the piece of learning outlier data OD_{G,n,ts-te} having a shorter waveform length to a beginning side of the piece of learning outlier data OD_{G,n,ts-te} having a shorter waveform length, the waveform classifying unit 13 aligns the beginning of the piece of learning outlier data OD_{G,n,ts-te} having a shorter waveform length with the beginning of the piece of learning outlier data OD_{G,n,ts-te} having the longest waveform length.

In addition, by disposing the piece of learning outlier data OD_{G,n,ts-te} having a shorter waveform length at the specified slide position, the end of the piece of learning outlier data OD_{G,n,ts-te} having a shorter waveform length may be located closer to a beginning side than the end of the piece of learning outlier data OD_{G,n,ts-te} having the longest waveform length.

By adding a piece of learning time-series data D_{G,n,t} at a time later than the piece of learning outlier data OD_{G,n,ts-te} having a shorter waveform length to an end side of the piece of learning outlier data OD_{G,n,ts-te} having a shorter waveform length, the waveform classifying unit 13 aligns the end of the piece of learning outlier data OD_{G,n,ts-te} having a shorter waveform length with the end of the piece of learning outlier data OD_{G,n,ts-te} having the longest waveform length.

The waveform classifying unit 13 classifies the same pieces of learning outlier data OD_{G,n,ts-te} having the same waveform length into the same group.

In the abnormality detection device illustrated in FIG. 1, the waveform classifying unit 13 classifies pieces of learning outlier data OD_{G,n,ts-te} having the degree of similarity equal to or higher than the threshold into the same group.

An observed value of a sensor may be the outside air temperature or the seawater temperature, or the observed value of the sensor may be affected by external factors from other equipment. In these cases, since a waveform related to an event appears in a long-term trend of the learning outlier data OD_{G,n,ts-te}, even when pieces of the learning outlier data OD_{G,n,ts-te} have similar waveforms or change widths to each other, ranges of observed values may be different from each other.

When the ranges of observed values included in the pieces of learning outlier data OD_{G,n,ts-te} are different from each other, the waveform classifying unit 13 may classify the pieces of learning outlier data OD_{G,n,ts-te} into different groups because the pieces of learning outlier data OD_{G,n,ts-te} are not similar to each other.

Therefore, the waveform classifying unit 13 calculates a mean value M of waveforms of each of the one or more pieces of learning outlier data OD_{G,n,ts-te} whose waveforms have been determined to be of the same type by the type determining unit 9.

The waveform classifying unit 13 subtracts the mean value M of waveforms of each of the one or more pieces of learning outlier data OD_{G,n,ts-te} from a value at each time t.

When the waveform classifying unit 13 subtracts the mean value M of waveforms of each of the one or more pieces of learning outlier data OD_{G,n,ts-te} from a value at each time t, the ranges of observed values included in the one or more pieces of learning outlier data OD_{G,n,ts-te} can be the same.

In addition, when a change width of the one or more pieces of learning outlier data OD_{G,n,ts-te} is also affected by external factors, the waveform classifying unit 13 may divide a value of each of the one or more pieces of learning outlier data OD_{G,n,ts-te} at each time t by a standard deviation of the pieces of learning outlier data OD_{G,n,ts-te}.

By dividing a value of each of the one or more pieces of learning outlier data OD_{G,n,ts-te} at each time t by the standard deviation, the influence of external factors can be reduced.

In addition, the one or more pieces of learning outlier data OD_{G,n,ts-te} may fluctuate in a time direction. For example, in an event waveform that appears in temperature data, the speed of temperature rise is high and the speed of temperature fall is slow in summer. On the contrary, the speed of temperature rise is low, and the speed of temperature fall is high in winter.

When the one or more pieces of learning outlier data OD_{G,n,ts-te} fluctuate in the time direction, the waveform classifying unit 13 calculates a DTW distance between the one or more pieces of learning outlier data OD_{G,n,ts-te} by using a dynamic time warping method.

By expanding and contracting each of waveforms of the one or more pieces of learning outlier data OD_{G,n,ts-te} according to an expansion and contraction path obtained by calculating the DTW distance, the waveform classifying unit 13 can eliminate the fluctuation of the learning outlier data OD_{G,n,ts-te} in the time direction. The expansion and contraction path indicates time corresponding to one or more pieces of learning outlier data OD_{G,n,ts-te} obtained when a distance between the one or more pieces of learning outlier data OD_{G,n,ts-te} is a minimum. Since a process itself for expanding and contracting the waveform of learning outlier data OD_{G,n,ts-te} according to an expansion and contraction path is a known technique, detailed description thereof is omitted.

In the abnormality detection device illustrated in FIG. 1, the waveform condition generation processing unit 14 calculates an upper limit value Bᵤₚₚₑᵣ[t] of a band model or the like by using a mean value Pₘₑₐₙ[t] of one or more pieces of learning outlier data OD_{G,n,ts-te} included in a group at each time t.

However, this is only an example, and instead of using a mean value Pₘₑₐₙ[t] at time t, the waveform condition generation processing unit 14 may use an observed value at time t included in a representative piece of learning outlier data OD_{G,n,ts-te} out of one or more pieces of learning outlier data OD_{G,n,ts-te} included in a group.

As the representative piece of learning outlier data OD_{G,n,ts-te}, a piece of learning outlier data OD_{G,n,ts-te} having the highest degree of similarity to mean outlier data of one or more pieces of learning outlier data OD_{G,n,ts-te} included in a group can be used.

In the abnormality detection device illustrated in FIG. 1, the waveform condition generation processing unit 14 calculates an upper limit value Bᵤₚₚₑᵣ[t] and a lower limit value B_{lower}[t] of a normal range indicated by a band model.

The waveform condition generation processing unit 14 may extend the normal range indicated by the band model by calculating a margin of the normal range from a width of the normal range, and adding the margin to the normal range.

This will be specifically described as follows.

As illustrated in the following formula (13), the waveform condition generation processing unit 14 calculates a margin r of the normal range from the width of the normal range indicated by the band model.

r=(max(Bᵤₚₚₑᵣ[t])−min(B_{lower}[t]))×η (13)

In formula (13), max(Bᵤₚₚₑᵣ[t]) represents a maximum value out of upper limit values Bᵤₚₚₑᵣ[t] in the period ts-te, min(B_{lower}[t]) represents a minimum value out of lower limit values B_{lower}[t] in the period ts-te, and η represents a coefficient equal to or more than 0. The coefficient η may be stored in an internal memory of the waveform condition generation processing unit 14 or may be given from the outside.

The waveform condition generation processing unit 14 extends the normal range by adding the margin r to the upper limit value Bᵤₚₚₑᵣ[t] as illustrated in the following formula (14) and subtracting the margin r from the lower limit value B_{lower}[t] as illustrated in the following formula (15).

Bᵤₚₚₑᵣ[t]←Bᵤₚₚₑᵣ[t]+r (14)

B_{lower}[t]←B_{lower}[t]−r (15)

Here, the waveform condition generation processing unit 14 calculates the margin r of the normal range according to formula (13). However, this is only an example, and the waveform condition generation processing unit 14 may calculate the margin r of the normal range according to the following formula (16).

$$r = \frac{( \begin{matrix}( {B}_{upper} [ ts ] - {B}_{lower} [ ts ] ) + ( {B}_{upper} [ ts + 1 ] - {B}_{lower} [ ts ] + \\ 1 ) + ... + ( {B}_{upper} [ te ] - {B}_{lower} [ te ] )\end{matrix} )}{p} \times η \qquad ( 16 )$$

In formula (16), p represents the number of times tin the period ts-te.

### Second Embodiment

In the abnormality detection device illustrated in FIG. 1, the waveform condition generation processing unit 14 generates a band model indicating a normal range of a waveform as a waveform condition Wp.

In the second embodiment, an abnormality detection device will be described in which the waveform condition generation processing unit 14 generates a histogram indicating a time period in which learning outlier data OD_{G,n,ts-te} is generated when equipment is operating normally, as a waveform condition Wp.

The configuration of the abnormality detection device of the second embodiment is similar to the configuration of the abnormality detection device of the first embodiment, and the configuration diagram of the abnormality detection device of the second embodiment is illustrated in FIG. 1.

The waveform condition generation processing unit 14 generates, for each of groups provided by the waveform classifying unit 13, a histogram indicating a time period in which one or more pieces of learning outlier data OD_{G,n,ts-te} included in the group are generated, as a waveform condition Wp.

The learning outlier data OD_{G,n,ts-te} includes period information indicating a period ts-te in which a learning outlier score S_{G,n,t} is equal to or more than a threshold Sₜₕ. The period information includes information indicating a start time when the learning outlier score S_{G,n,t} becomes equal to or more than the threshold Sₜh, and information indicating an end time when the learning outlier score S_{G,n,t} becomes equal to or less than the threshold Sₜₕ.

The information indicating the start time and the information indicating the end time each include not only information indicating a so-called time but also information indicating a date and information indicating a day of the week.

Since a process itself for generating a histogram is a known technique, detailed description thereof is omitted, but a histogram can be generated on the basis of the period ts-te indicated by the period information included in the learning outlier data OD_{G,n,ts-te}.

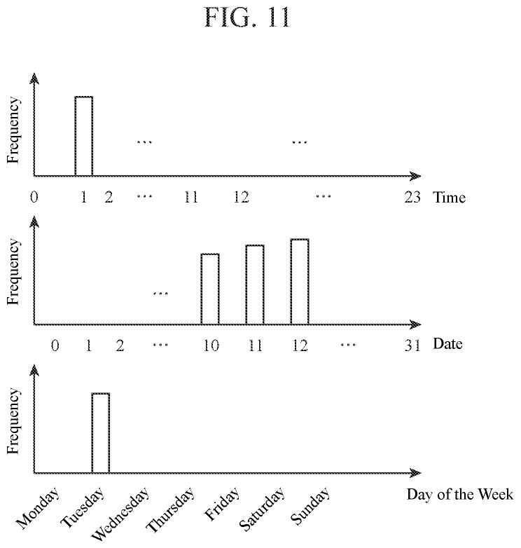

FIG. 11 is an explanatory diagram illustrating an example of a histogram generated by the waveform condition generation processing unit 14.

In FIG. 11, the horizontal axis indicates a time, a date, or a day of the week, and the vertical axis indicates a frequency at which learning outlier data OD_{G,n,ts-te} occurs.

FIG. 11 illustrates an example in which the learning outlier data OD_{G,n,ts-te} occurs between 1:00 and 2:00, the learning outlier data OD_{G,n,ts-te} occurs on the 10th to 12th, and the learning outlier data OD_{G,n,ts-te} occurs on Tuesday.

As in the first embodiment, the waveform condition selecting unit 10 calculates the degree of similarity between abnormality detection outlier data OD_{U,ts′-te′} output from the type determining unit 9 and each of N pieces of learning outlier data OD_{G,n,ts-te}.

As in the first embodiment, the waveform condition selecting unit 10 searches for a piece of learning outlier data OD_{G,n,ts-te} having the highest degree of similarity to the abnormality detection outlier data OD_{U,ts′-te′} among N pieces of learning outlier data OD_{G,n,ts-te}.

As in the first embodiment, the waveform condition selecting unit 10 selects a waveform condition Wp corresponding to a group including the learning outlier data OD_{G,n,ts-te} that has been searched for from among waveform conditions Wp corresponding to one or more groups stored by the waveform condition storing unit 15.

The waveform condition Wp selected by the waveform condition selecting unit 10 is a histogram generated by the waveform condition generation processing unit 14.

The waveform condition selecting unit 10 outputs the selected waveform condition Wp to the abnormality determination processing unit 11.

The abnormality determination processing unit 11 refers to period information included in the abnormality detection outlier data OD_{U,ts′-te′} output from the outlier data extraction processing unit 7, and recognizes a period ts′-te′ which is a time period in which abnormality detection outlier data OD_{U,ts′-te′} occurs.

The abnormality determination processing unit 11 collates the period ts′-te′ in which abnormality detection outlier data OD_{U,ts′-te′} is generated with a generation time period indicated by a histogram which is a waveform condition Wp output from the waveform condition selecting unit 10.

The abnormality determination processing unit 11 determines that equipment is operating normally when the period ts′-te′ in which the abnormality detection outlier data OD_{U,ts′-te′} is generated is included in the generation time period indicated by the histogram.

In the example of FIG. 11, the abnormality determination processing unit 11 determines that equipment is operating normally when a time period in which the abnormality detection outlier data OD_{U,ts′-te′} is generated is between 1:00 and 2:00, on any day of the 10th to 12th, and on Tuesday.

The abnormality determination processing unit 11 determines that equipment is operating abnormally when the period ts′-te′ in which the abnormality detection outlier data OD_{U,ts′-te′} is generated is not included in the generation time period indicated by the histogram.

In the example of FIG. 11, the abnormality determination processing unit 11 determines that equipment is operating abnormally when a time period in which the abnormality detection outlier data OD_{U,ts′-te′} is generated is not between 1:00 and 2:00, not on any day of the 10th to 12th, or not on Tuesday.

In the second embodiment described above, the abnormality detection device is configured in such a manner that the abnormality determining unit 8 determines that equipment is operating normally when a time period in which abnormality detection outlier data extracted by the outlier data extracting unit 4 is generated is included in a generation time period indicated by a histogram, and determines that the equipment is operating abnormally when the time period in which the abnormality detection outlier data is generated is not included in the generation time period indicated by the histogram. Therefore, the abnormality detection device can avoid occurrence of erroneous determination indicating that an abnormality has occurred in the equipment without preparing event information in advance.

In the abnormality detection device of the second embodiment, the abnormality determination processing unit 11 determines that equipment is operating normally when a time period in which the abnormality detection outlier data OD_{U,ts′-te′} is generated is included in the generation time period indicated by the histogram.

In the abnormality detection device of the second embodiment, as in the abnormality detection device of the first embodiment, the abnormality determination processing unit 11 determines whether or not the waveform of the abnormality detection outlier data OD_{U,ts′-te′} is within a normal range of a bandpass over the entire period ts′-te′.

Then, the abnormality determination processing unit 11 may determine that equipment is operating normally when the time period in which the abnormality detection outlier data OD_{U,ts′-te′} is generated is included in the generation time period indicated by the histogram, and the waveform of the abnormality detection outlier data OD_{U,ts′-te′} is included in the normal range of the bandpass over the entire period ts′-te′.

### Third Embodiment

In a third embodiment, an abnormality detection device including a selection accepting unit 17 for presenting waveform conditions Wp generated by the waveform condition generation processing unit 14 and accepting user's selection of an effective waveform condition Wp from among the presented waveform conditions Wp will be described.

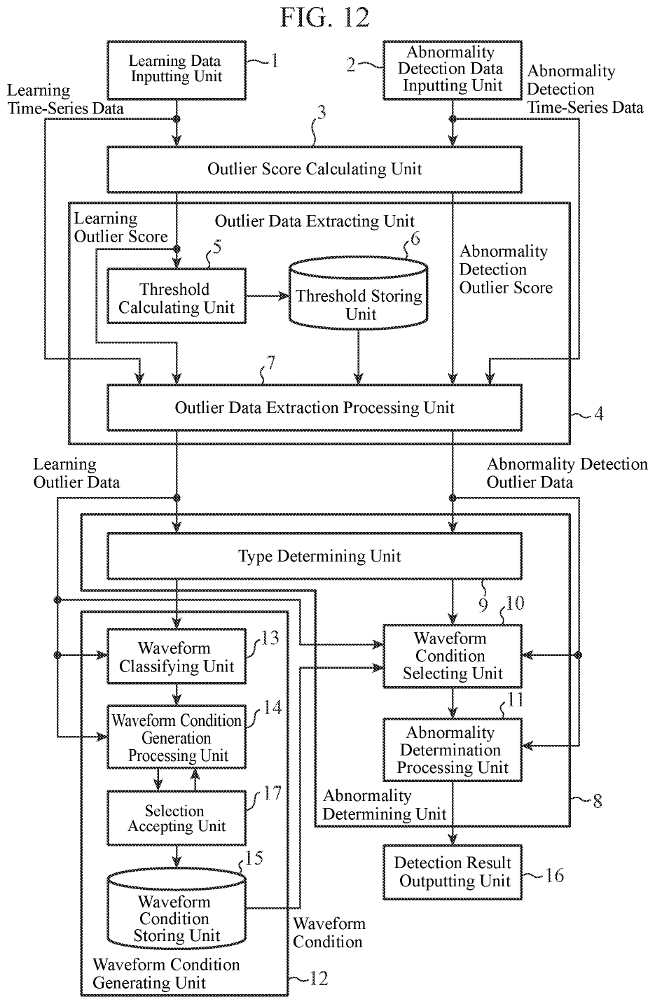

FIG. 12 is a configuration diagram illustrating the abnormality detection device according to the third embodiment.

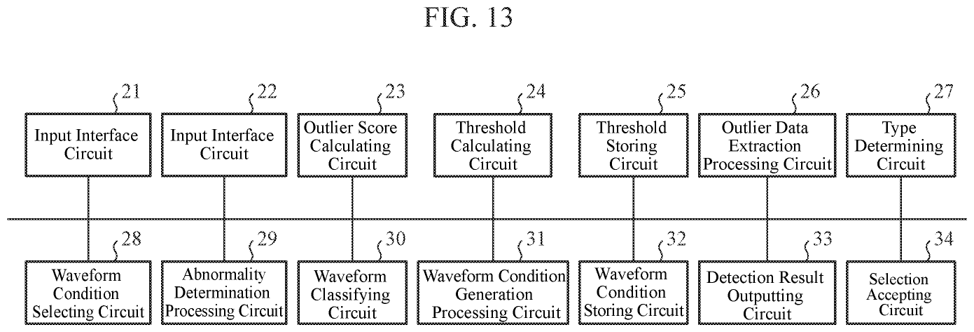

FIG. 13 is a hardware configuration diagram illustrating hardware of the abnormality detection device according to the third embodiment.

In FIGS. 12 and 13, the same reference numerals as in FIGS. 1 and 2 indicate the same or corresponding parts, and therefore description thereof is omitted.

The selection accepting unit 17 is achieved by, for example, a selection accepting circuit 34 illustrated in FIG. 13.

The selection accepting unit 17 presents waveform conditions Wp generated by the waveform condition generation processing unit 14 and accepts user's selection of an effective waveform condition Wp from among the presented waveform conditions Wp.

The selection accepting unit 17 leaves only an effective waveform condition Wp whose selection has been accepted as a waveform condition Wp generated by the waveform condition generation processing unit 14, and discards a waveform condition Wp whose selection has not been accepted.

In FIG. 12, it is assumed that each of the learning data inputting unit 1, the abnormality detection data inputting unit 2, the outlier score calculating unit 3, the threshold calculating unit 5, the threshold storing unit 6, the outlier data extraction processing unit 7, the type determining unit 9, the waveform condition selecting unit 10, the abnormality determination processing unit 11, the waveform classifying unit 13, the waveform condition generation processing unit 14, the waveform condition storing unit 15, the detection result outputting unit 16, and the selection accepting unit 17, which are constituent elements of the abnormality detection device, is achieved by dedicated hardware as illustrated in FIG. 13. That is, it is assumed that the abnormality detection device is achieved by the input interface circuit 21, the input interface circuit 22, the outlier score calculating circuit 23, the threshold calculating circuit 24, the threshold storing circuit 25, the outlier data extraction processing circuit 26, the type determining circuit 27, the waveform condition selecting circuit 28, the abnormality determination processing circuit 29, the waveform classifying circuit 30, the waveform condition generation processing circuit 31, the waveform condition storing circuit 32, the detection result outputting circuit 33, and the selection accepting circuit 34.

Here, for example, to each of the input interface circuit 21, the input interface circuit 22, the outlier score calculating circuit 23, the threshold calculating circuit 24, the outlier data extraction processing circuit 26, the type determining circuit 27, the waveform condition selecting circuit 28, the abnormality determination processing circuit 29, the waveform classifying circuit 30, the waveform condition generation processing circuit 31, the detection result outputting circuit 33, and the selection accepting circuit 34, a single circuit, a composite circuit, a programmed processor, a parallel programmed processor, ASIC, FPGA, or a combination thereof is applicable.

The constituent elements of the abnormality detection device are not limited to those achieved by dedicated hardware, and the abnormality detection device may be achieved by software, firmware, or a combination of software and firmware.

When the abnormality detection device is achieved by software, firmware, or the like, the threshold storing unit 6 and the waveform condition storing unit 15 are configured on a memory 41 of a computer. A program for causing the computer to execute a processing procedure performed in the learning data inputting unit 1, the abnormality detection data inputting unit 2, the outlier score calculating unit 3, the threshold calculating unit 5, the outlier data extraction processing unit 7, the type determining unit 9, the waveform condition selecting unit 10, the abnormality determination processing unit 11, the waveform classifying unit 13, the waveform condition generation processing unit 14, the detection result outputting unit 16, and the selection accepting unit 17 is stored in the memory 41 illustrated in FIG. 3. Then, the processor 42 illustrated in FIG. 3 executes the program stored in the memory 41.

Next, an operation of the abnormality detection device illustrated in FIG. 12 will be described.

Provided that constituent elements other than the selection accepting unit 17 among the constituent elements of the abnormality detection device illustrated in FIG. 12 are similar to those of the abnormality detection device illustrated in FIG. 1, and therefore only an operation of the selection accepting unit 17 will be described here.

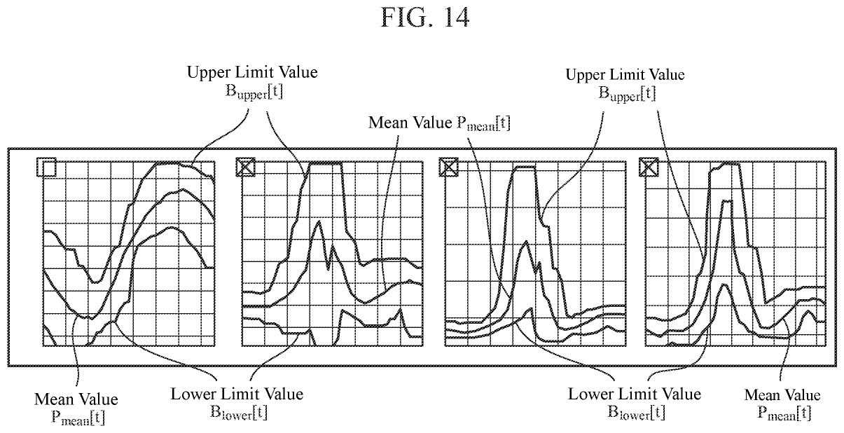

As illustrated in FIG. 14, the selection accepting unit 17 displays one or more waveform conditions Wp generated by the waveform condition generation processing unit 14 on, for example, a display (not illustrated).

FIG. 14 is an explanatory diagram illustrating a list confirmation screen displaying a list of one or more waveform conditions Wp generated by the waveform condition generation processing unit 14.

A user can evaluate appropriateness of each of the waveform conditions Wp by confirming the list confirmation screen.

The list confirmation screen illustrated in FIG. 14 includes a check box corresponding to each of the waveform conditions Wp. By checking a check box corresponding to a waveform condition Wp determined to be appropriate among the check boxes corresponding to the respective waveform conditions Wp, a user can select an effective waveform condition Wp.

The list confirmation screen illustrated in FIG. 14 displays four waveform conditions Wp. In the drawing, the check boxes for the second to fourth waveform conditions Wp from the left are checked.

The selection accepting unit 17 accepts user's selection of a waveform condition Wp whose check box has been checked by a user among the one or more waveform conditions Wp generated by the waveform condition generation processing unit 14, as an effective waveform condition Wp.

The selection accepting unit 17 causes the waveform condition storing unit 15 to store only an effective waveform condition Wp whose selection has been accepted as a waveform condition Wp generated by the waveform condition generation processing unit 14.

The selection accepting unit 17 discards a waveform condition Wp whose selection has not been accepted, and does not causes the waveform condition storing unit 15 to store the waveform condition Wp whose selection has not been accepted.

The selection accepting unit 17 has a function of displaying learning outlier data OD_{G,n,ts-te} from which the waveform conditions Wp displayed on the list confirmation screen have been generated on a display (not illustrated).

When a user clicks on any waveform condition Wp among the one or more waveform conditions Wp displayed on the list confirmation screen, the selection accepting unit 17 displays one or more pieces of learning outlier data OD_{G,n,ts-te} from which the waveform condition Wp has been generated on a display (not illustrated).

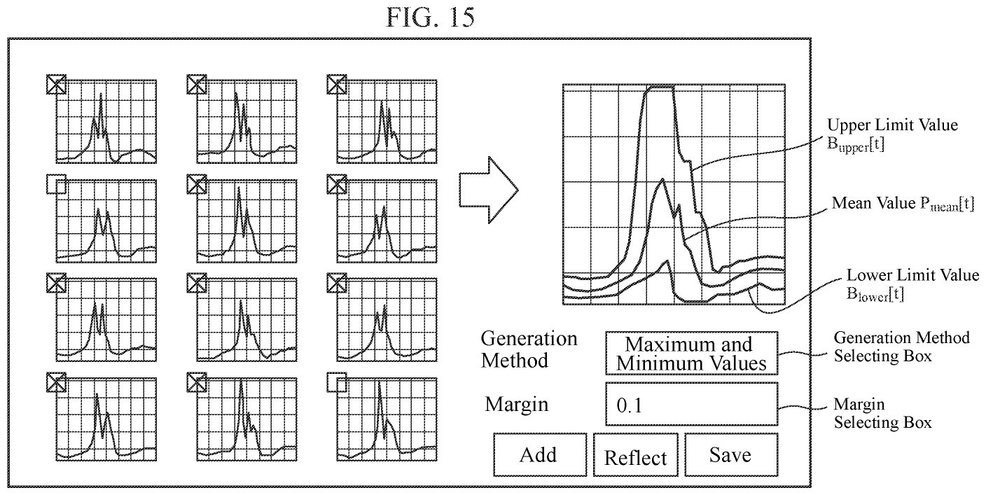

FIG. 15 is an explanatory diagram illustrating the list confirmation screen displaying the list of pieces of learning outlier data OD_{G,n,ts-te} from which a waveform condition Wp has been generated.

The list confirmation screen illustrated in FIG. 15 displays 12 pieces of learning outlier data OD_{G,n,ts-te}.

By confirming the list confirmation screen, a user can determine a piece of learning outlier data OD_{G,n,ts-te} which is considered to be unnecessary for generating a waveform condition Wp out of the 12 pieces of learning outlier data OD_{G,n,ts-te}.

The list confirmation screen illustrated in FIG. 15 includes check boxes corresponding to the respective pieces of learning outlier data OD_{G,n,ts-te}. By unchecking a check box corresponding to a piece of learning outlier data OD_{G,n,ts-te} which is considered to be unnecessary out of the check boxes corresponding to the respective pieces of learning outlier data OD_{G,n,ts-te}, a user can select a piece of learning outlier data OD_{G,n,ts-te} which is considered to be unnecessary.

In the example of FIG. 15, the check box for the second piece of learning outlier data OD_{G,n,ts-te} from the top in the leftmost column is unchecked. The check box for the fourth piece of learning outlier data OD_{G,n,ts-te} from the top in the rightmost column is unchecked.

The selection accepting unit 17 accepts user's selection of a piece of learning outlier data OD_{G,n,ts-te} whose check box is not unchecked out of the 12 pieces of learning outlier data OD_{G,n,ts-te}.

The waveform condition generation processing unit 14 regenerates a waveform condition Wp from a piece of learning outlier data OD_{G,n,ts-te} whose selection has been accepted by the selection accepting unit 17.

The list confirmation screen illustrated in FIG. 15 includes a selection box for accepting user's selection of a method for generating a waveform condition Wp by the waveform condition generation processing unit 14.

In the generation method selecting box, a generation method for calculating an upper limit value Bᵤₚₚₑᵣ[ₜ] and a lower limit value B_{lower}[t] of a normal range indicated by a band model which is a waveform condition Wp can be selected by using a mean value Pₘₑₐₙ[t] and a standard deviation P_{std}[t].

In addition, in the generation method selecting box, the generation method for calculating an upper limit value Bᵤₚₚₑᵣ[ₜ] and a lower limit value B_{lower}[t] of a normal range indicated by a band model can be selected by using a maximum value Pₘₐₓ[t] and a minimum value Pₘᵢₙ[t].

Therefore, a user can select a method for generating a waveform condition Wp by operating the generation method selecting box.

The selection accepting unit 17 accepts user's selection of a method for generating a waveform condition Wp, the selection being caused by an operation of the generation method selecting box by a user.

The waveform condition generation processing unit 14 generates a waveform condition Wp from a piece of learning outlier data OD_{G,n,ts-te} whose selection has been accepted by the selection accepting unit 17 on the basis of a generation method whose selection has been accepted by the selection accepting unit 17.

The list confirmation screen illustrated in FIG. 15 includes a margin selecting box for accepting user's selection of a margin of a normal range indicated by a band model.

Therefore, a user can select a margin by operating the margin selecting box.

The selection accepting unit 17 accepts user's selection of a margin, the selection being caused by an operation of the margin selecting box by a user.

The waveform condition generation processing unit 14 extends the normal range by adding a margin whose selection has been accepted by the selection accepting unit 17 to the normal range.

The list confirmation screen illustrated in FIG. 15 includes a “reflect” button, a “save” button, and an “add” button.

When a user clicks the “reflect” button, the waveform condition generation processing unit 14 regenerates a waveform condition Wp from a piece of learning outlier data OD_{G,n,ts-te} whose selection has been accepted by the selection accepting unit 17, and operates so as to display the regenerated waveform condition Wp on the list confirmation screen.

When the user clicks the “save” button, it is operated in such a manner that the waveform condition Wp regenerated by the selection accepting unit 17 is stored in the waveform condition storing unit 15.

When the user clicks the “add” button, it is operated in such a manner that a piece of learning outlier data OD_{G,n,ts-te} included in a group different from the group of the pieces of learning outlier data OD_{G,n,ts-te} displayed on the list confirmation screen illustrated in FIG. 15 can be selected for regenerating a waveform condition Wp. Then, after the user clicks the “add” button, the user clicks a waveform condition Wp different from the previously clicked waveform condition Wp on the list confirmation screen illustrated in FIG. 14. When the user clicks on a different waveform condition Wp, the selection accepting unit 17 displays one or more pieces of learning outlier data OD_{G,n,ts-te} from which the clicked waveform condition Wp has been generated on the list confirmation screen illustrated in FIG. 15.

In the list confirmation screen illustrated in FIG. 15, by checking a check box of a piece of learning outlier data OD_{G,n,ts-te} which is considered to be added for regenerating a waveform condition Wp, the user can select the piece of learning outlier data OD_{G,n,ts-te} which is considered to be added.

In the third embodiment described above, the abnormality detection device is configured in such a manner that the selection accepting unit 17 presents a waveform condition Wp generated by the waveform condition generation processing unit 14, accepts user's selection of an effective waveform condition Wp from among the presented waveform conditions Wp, leaves only the effective waveform condition Wp whose selection has been accepted as a waveform condition Wp generated by the waveform condition generation processing unit 14, and discards a waveform condition Wp whose selection has not been accepted. Therefore, the abnormality detection device can generate a waveform condition Wp reflecting determination of a user.

### Fourth Embodiment

In a fourth embodiment, an abnormality detection device will be described in which the waveform condition generating unit 12 uses, as learning outlier data OD_{G,n,ts-te}, a piece of abnormality detection outlier data OD_{U,ts′-te′} collated with a waveform condition Wp when the abnormality determining unit 8 determines that equipment is operating abnormally.

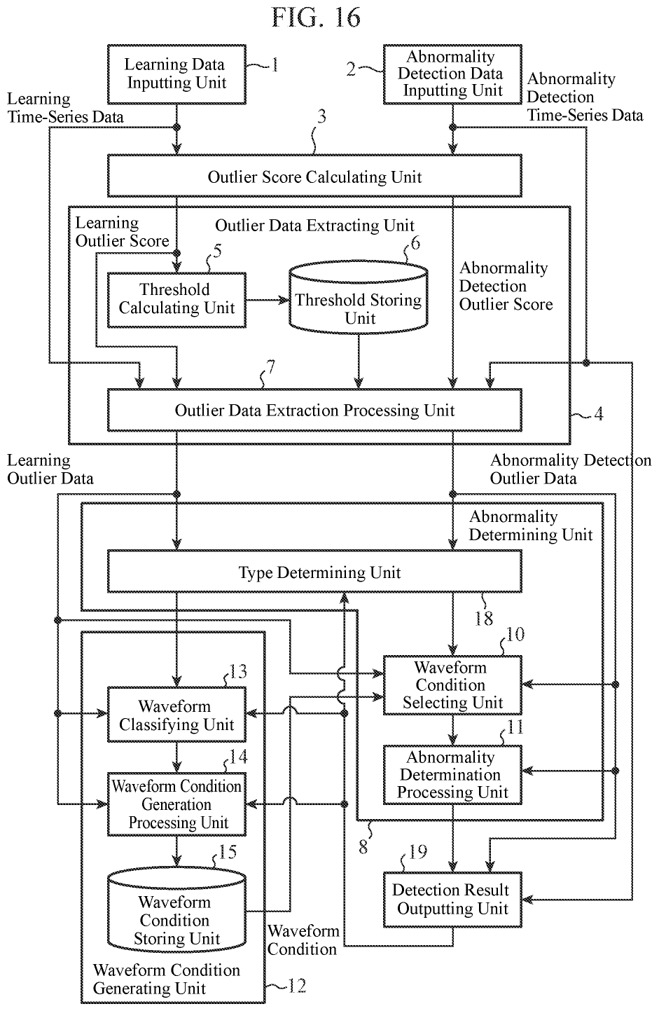

FIG. 16 is a configuration diagram illustrating the abnormality detection device according to the fourth embodiment.

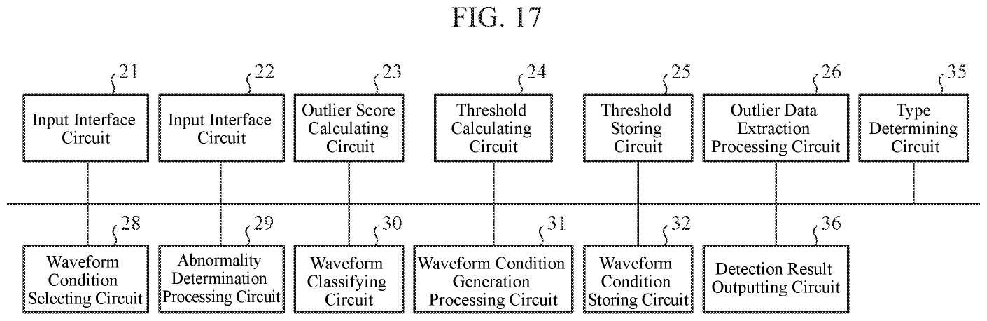

FIG. 17 is a hardware configuration diagram illustrating hardware of the abnormality detection device according to the fourth embodiment.

In FIGS. 16 and 17, the same reference numerals as in FIGS. 1 and 2 indicate the same or corresponding parts, and therefore description thereof is omitted.

A type determining unit 18 is achieved by, for example, a type determining circuit 35 illustrated in FIG. 17.

As in the type determining unit 9 illustrated in FIG. 1, the type determining unit 18 determines the type of learning outlier data OD_{G,n,ts-te} extracted by the outlier data extraction processing unit 7.

As in the type determining unit 9 illustrated in FIG. 1, the type determining unit 18 determines the waveform type of abnormality detection outlier data OD_{U,ts′-te′} extracted by the outlier data extraction processing unit 7.

The type determining unit 18 acquires, as learning outlier data OD_{G,n,ts-te}, a piece of abnormality detection outlier data OD_{U,ts′-te′} collated with a waveform condition Wp from a detection result outputting unit 19 when the abnormality determination processing unit 11 determines that equipment is operating abnormally.

The type determining unit 18 calculates a feature amount of the acquired abnormality detection outlier data OD_{U,ts′-te′}, and determines the waveform type of the abnormality detection outlier data OD_{U,ts′-te′} from the calculated feature amount. The type determining unit 18 outputs the determined waveform type of the abnormality detection outlier data OD_{U,ts′-te′} to the waveform classifying unit 13.

The detection result outputting unit 19 is achieved by, for example, a detection result outputting circuit 36 illustrated in FIG. 17.

As in the detection result outputting unit 16 illustrated in FIG. 1, the detection result outputting unit 19 displays the determination result output from the abnormality determination processing unit 11 on, for example, a display (not illustrated).

The detection result outputting unit 19 displays a piece of abnormality detection outlier data OD_{U,ts′-te′} collated with a waveform condition Wp and abnormality detection time-series data D_{U,t} on, for example, a display when the abnormality determination processing unit 11 determines that equipment is operating abnormally.

The detection result outputting unit 19 accepts user's selection of a piece of abnormality detection outlier data OD_{U,ts′-te′} used as learning outlier data OD_{G,n,ts-te} among pieces of abnormality detection outlier data OD_{U,ts′-te′} collated with a waveform condition Wp when the abnormality determination processing unit 11 determines that equipment is operating abnormally.

The detection result outputting unit 19 outputs, as learning outlier data OD_{G,n,ts-te}, the piece of abnormality detection outlier data OD_{U,ts′-te′} whose selection has been accepted to each of the type determining unit 18, the waveform classifying unit 13, and the waveform condition generation processing unit 14.

In FIG. 16, it is assumed that each of the learning data inputting unit 1, the abnormality detection data inputting unit 2, the outlier score calculating unit 3, the threshold calculating unit 5, the threshold storing unit 6, the outlier data extraction processing unit 7, the type determining unit 18, the waveform condition selecting unit 10, the abnormality determination processing unit 11, the waveform classifying unit 13, the waveform condition generation processing unit 14, the waveform condition storing unit 15, and the detection result outputting unit 19, which are constituent elements of the abnormality detection device, is achieved by dedicated hardware as illustrated in FIG. 17. That is, it is assumed that the abnormality detection device is achieved by the input interface circuit 21, the input interface circuit 22, the outlier score calculating circuit 23, the threshold calculating circuit 24, the threshold storing circuit 25, the outlier data extraction processing circuit 26, the type determining circuit 35, the waveform condition selecting circuit 28, the abnormality determination processing circuit 29, the waveform classifying circuit 30, the waveform condition generation processing circuit 31, the waveform condition storing circuit 32, and the detection result outputting circuit 36.

Here, for example, to each of the input interface circuit 21, the input interface circuit 22, the outlier score calculating circuit 23, the threshold calculating circuit 24, the outlier data extraction processing circuit 26, the type determining circuit 35, the waveform condition selecting circuit 28, the abnormality determination processing circuit 29, the waveform classifying circuit 30, the waveform condition generation processing circuit 31, and the detection result outputting circuit 36, a single circuit, a composite circuit, a programmed processor, a parallel programmed processor, ASIC, FPGA, or a combination thereof is applicable.

The constituent elements of the abnormality detection device are not limited to those achieved by dedicated hardware, and the abnormality detection device may be achieved by software, firmware, or a combination of software and firmware.

When the abnormality detection device is achieved by software, firmware, or the like, the threshold storing unit 6 and the waveform condition storing unit 15 are configured on a memory 41 of a computer. A program for causing the computer to execute a processing procedure performed in the learning data inputting unit 1, the abnormality detection data inputting unit 2, the outlier score calculating unit 3, the threshold calculating unit 5, the outlier data extraction processing unit 7, the type determining unit 18, the waveform condition selecting unit 10, the abnormality determination processing unit 11, the waveform classifying unit 13, the waveform condition generation processing unit 14, and the detection result outputting unit 19 is stored in the memory 41 illustrated in FIG. 3. Then, the processor 42 illustrated in FIG. 3 executes the program stored in the memory 41.

Next, an operation of the abnormality detection device illustrated in FIG. 16 will be described.

As in the first embodiment, the abnormality determination processing unit 11 collates a waveform condition Wp selected by the waveform condition selecting unit 10 with a waveform of the abnormality detection outlier data OD_{U,ts′-te′} extracted by the outlier data extraction processing unit 7.

As in the first embodiment, the abnormality determination processing unit 11 determines whether or not equipment is operating abnormally on the basis of a collation result between the waveform condition Wp and the waveform of abnormality detection outlier data OD_{U,ts′-te′}.

As in the first embodiment, the abnormality determination processing unit 11 outputs a determination result indicating whether or not the equipment is operating abnormally to the detection result outputting unit 19.

When determining that the equipment is operating abnormally, the abnormality determination processing unit 11 outputs a piece of abnormality detection outlier data OD_{U,ts′-te′} collated with the waveform condition Wp to the detection result outputting unit 19.

The detection result outputting unit 19 displays the determination result output from the abnormality determination processing unit 11 on, for example, a display (not illustrated).

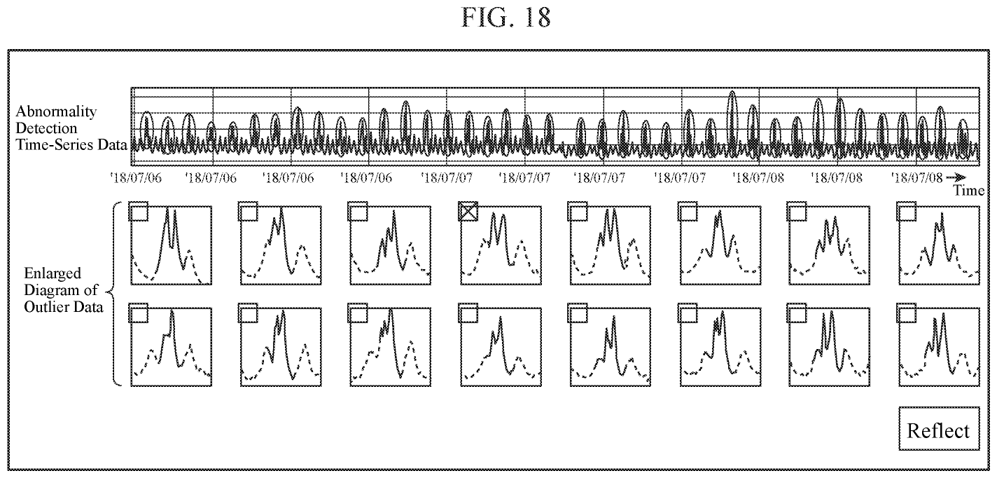

As illustrated in FIG. 18, the detection result outputting unit 19 displays pieces of abnormality detection outlier data OD_{U,ts′-te′} collated with waveform conditions Wp and pieces of abnormality detection time-series data D_{U,t} output from the abnormality detection data inputting unit 2 on, for example, a display when the abnormality determination processing unit 11 determines that equipment is operating abnormally.

FIG. 18 is an explanatory diagram illustrating an example of a data display screen displaying pieces of abnormality detection outlier data OD_{U,ts′-te′} collated with waveform conditions Wp and pieces of abnormality detection time-series data D_{U,t} when the abnormality determination processing unit 11 determines that equipment is operating abnormally.

In FIG. 18, out of pieces of abnormality detection time-series data D_{U,t}, a piece of data surrounded by ∘ is a piece of abnormality detection outlier data OD_{U,ts′-te′} collated with a waveform condition Wp when the abnormality determination processing unit 11 determines that equipment is operating abnormally. Enlarged diagrams of the abnormality detection outlier data OD_{U,ts′-te′} are also displayed on the screen illustrated in FIG. 18.

In the enlarged diagrams, the solid line part indicates abnormality detection outlier data OD_{U,ts′-te′} and the broken line part indicates abnormality detection time-series data D_{U,t} before and after the abnormality detection outlier data OD_{U,ts′-te′}.

In FIG. 18, in order to simplify the drawing, the number of enlarged diagrams of abnormality detection outlier data OD_{U,ts′-te′} is smaller than the number of pieces of data surrounded by ∘.

The data display screen illustrated in FIG. 18 includes check boxes corresponding to the respective pieces of abnormality detection outlier data OD_{U,ts′-te′}. By checking a check box corresponding to a piece of abnormality detection outlier data OD_{U,ts′-te′} which is desirably used as learning outlier data OD_{G, n, ts-te}, a user can select a piece of abnormality detection outlier data OD_{U,ts′-te′} used as learning outlier data OD_{G,n,ts-te}.

In the example of FIG. 18, the check box for the fourth piece of abnormality detection outlier data OD_{U,ts′-te′} from the left in the upper row is checked.

The detection result outputting unit 19 accepts, as learning outlier data OD_{G,n,ts-te}, user's selection of the piece of abnormality detection outlier data OD_{U,ts′-te′} whose check box has been checked by a user.

The detection result outputting unit 19 outputs, as learning outlier data OD_{G,n,ts-te}, the piece of abnormality detection outlier data OD_{U,ts′-te′} whose selection has been accepted to each of the type determining unit 18, the waveform classifying unit 13, and the waveform condition generation processing unit 14.

As in the type determining unit 9 illustrated in FIG. 1, the type determining unit 18 determines the type of learning outlier data OD_{G,n,ts-te} extracted by the outlier data extraction processing unit 7, and outputs the type of learning outlier data OD_{G,n,ts-te} to the waveform classifying unit 13.

As in the type determining unit 9 illustrated in FIG. 1, the type determining unit 18 determines the waveform type of abnormality detection outlier data OD_{U,ts′-te′} extracted by the outlier data extraction processing unit 7, and outputs the waveform type of abnormality detection outlier data OD_{U,ts′-te′} to the waveform condition selecting unit 10.

The type determining unit 18 acquires, as learning outlier data OD_{G,n,ts-te}, the abnormality detection outlier data OD_{U,ts′-te′} output from the detection result outputting unit 19.

The type determining unit 18 calculates a feature amount of the acquired abnormality detection outlier data OD_{U,ts′-te′}, and determines the waveform type of the abnormality detection outlier data OD_{U,ts′-te′} from the calculated feature amount.

A process for determining the waveform type of the abnormality detection outlier data OD_{U,ts′-te′} is similar to the process for determining the waveform type of the learning outlier data OD_{G,n,ts-te}.

The type determining unit 18 outputs the determined waveform type of the abnormality detection outlier data OD_{U,ts′-te′} to the waveform classifying unit 13.

Operations of the waveform classifying unit 13 and the waveform condition generation processing unit 14 are similar to those of the first embodiment except that abnormality detection outlier data OD_{U,ts′-te′} output from the detection result outputting unit 19 is used as learning outlier data OD_{G,n,ts-te}.

In the fourth embodiment described above, the abnormality detection device is configured in such a manner that when the abnormality determining unit 8 determines that equipment is operating abnormally, the type determining unit 18 calculates a feature amount of abnormality detection outlier data collated with a waveform condition, and determines the waveform type of the abnormality detection outlier data collated with the waveform condition from the feature amount, and then, the waveform condition generating unit 12 generates, from waveforms of one or more pieces of outlier data whose waveforms have been determined to be of the same type by the type determining unit 18 out of the pieces of learning outlier data extracted by the outlier data extracting unit 4 and the pieces of abnormality detection outlier data collated with waveform conditions, a waveform condition corresponding to the type. Therefore, the abnormality detection device can increase the number of pieces of learning outlier data and improve the accuracy of waveform conditions corresponding to the types thereof as compared with the abnormality detection device of the first embodiment.

Note that in the present invention, it is possible to freely combine the embodiments to each other, modify any constituent element in each of the embodiments, or omit any constituent element in each of the embodiments within the scope of the invention.

### INDUSTRIAL APPLICABILITY

The present invention is suitable for an abnormality detection device and an abnormality detection method for determining whether or not equipment is operating abnormally.

### REFERENCE SIGNS LIST

1: learning data inputting unit,
2: abnormality detection data inputting unit,
3: outlier score calculating unit,
4: outlier data extracting unit,
5: threshold calculating unit,
6: threshold storing unit,
7: outlier data extraction processing unit,
8: abnormality determining unit,
9: type determining unit,
10: waveform condition selecting unit,
11: abnormality determination processing unit,
12: waveform condition generating unit,
13: waveform classifying unit,
14: waveform condition generation processing unit,
15: waveform condition storing unit,
16: detection result outputting unit,
17: selection accepting unit,
18: type determining unit,
19: detection result outputting unit,
21: input interface circuit,
22: input interface circuit,
23: outlier score calculating circuit,
24: threshold calculating circuit,
25: threshold storing circuit,
26: outlier data extraction processing circuit,
27: type determining circuit,
28: waveform condition selecting circuit,
29: abnormality determination processing circuit,
30: waveform classifying circuit,
31: waveform condition generation processing circuit,
32: waveform condition storing circuit,
33: detection result outputting circuit,
34: selection accepting circuit,
35: type determining circuit,
36: detection result outputting circuit,
41: memory, and
42: processor

What is claimed is:

1. An abnormality detection device comprising:
processing circuitry
to calculate, from abnormality detection time-series data indicating states of equipment which is an abnormality detection target at a plurality of times in time series, a degree of abnormality of the equipment at each of the plurality of times as an abnormality detection outlier score;
to extract, from among pieces of the abnormality detection time-series data, a piece of abnormality detection time-series data in a time period in which an abnormality may have occurred in the equipment as abnormality detection outlier data on a basis of the abnormality detection outlier score at each of the plurality of times;
to collate a waveform of the abnormality detection outlier data with a waveform condition for determining that a waveform indicating a change in the abnormality detection outlier data is a waveform obtained when the equipment is operating normally, and to determine whether or not the equipment is operating abnormally on a basis of a collation result between the waveform condition and the waveform of the abnormality detection outlier data;
to calculate a feature amount of the abnormality detection outlier data, and to determine a waveform type of the abnormality detection outlier data from the feature amount;
to select a waveform condition corresponding to the type from among one or more waveform conditions;
to collate the waveform condition with the waveform of the abnormality detection outlier data, and to determine whether or not the equipment is operating abnormally on a basis of a collation result between the selected waveform condition and the waveform of the abnormality detection outlier data;
to calculate, from each of one or more pieces of learning time-series data indicating states of the equipment at a plurality of times when the equipment is operating normally in time series, a degree of abnormality of the equipment at each of the plurality of times as a learning outlier score;
to extract, from among the pieces of learning time-series data, learning time-series data in a time period in which an abnormality may have occurred in the equipment as learning outlier data on a basis of the learning outlier score at each of the plurality of times;
to calculate a feature amount of each of the pieces of learning outlier data, and to determine a waveform type of each of the pieces of learning outlier data from the feature amount of each of the pieces of learning outlier data; and
to generate, from among waveforms of one or more pieces of learning outlier data whose waveforms have been determined to be of the same type out of the pieces of learning outlier data, a waveform condition corresponding to the type.

2. The abnormality detection device according to claim 1, wherein
the processing circuitry:
classifies the one or more pieces of learning outlier data whose waveforms have been determined to be of the same type into groups on a basis of a degree of similarity between the waveforms of the one or more pieces of learning outlier data whose waveforms have been determined to be of the same type, and generates, for each of the groups, a waveform condition corresponding the group from the waveforms of the one or more pieces of learning outlier data included in the group, and
searches for a piece of learning outlier data having a highest degree of similarity to the abnormality detection outlier data among the pieces of learning outlier data, and selects a waveform condition corresponding to a group including the learning outlier data that has been searched for from among waveform conditions corresponding to the respective groups.

3. The abnormality detection device according to claim 1, wherein
the processing circuitry:
generates a band model indicating a normal range of a waveform as the waveform condition, and
determines that the equipment is operating normally when the waveform of the abnormality detection outlier data is included in the normal range indicated by the band model, and determines that the equipment is operating abnormally when the waveform of the abnormality detection outlier data deviates from the normal range indicated by the band model.

4. The abnormality detection device according to claim 3, wherein
even when the waveform of the abnormality detection outlier data deviates from the normal range indicated by the band model, the processing circuitry determines that the equipment is operating normally as long as the outlier is within an allowable range.

5. The abnormality detection device according to claim 1, wherein
the processing circuitry:
generates, as the waveform condition, a histogram indicating a time period in which outlier data is generated when the equipment is operating normally,
determines that the equipment is operating normally when the time period in which the abnormality detection outlier data is generated is included in a generation time period indicated by the histogram, and determines that the equipment is operating abnormally when the time period in which the abnormality detection outlier data is generated is not included in the generation time period indicated by the histogram.

6. The abnormality detection device according to claim 3, wherein
the processing circuitry generates the band model by using a mean value of waveforms of the respective pieces of learning outlier data and a standard deviation of the respective pieces of learning outlier data.

7. The abnormality detection device according to claim 3, wherein
the processing circuitry generates the band model by using a maximum value out of waveforms of the respective pieces of learning outlier data and a minimum value out of the waveforms of the respective pieces of learning outlier data.

8. The abnormality detection device according to claim 3, wherein
the processing circuitry extends a normal range indicated by the generated band model by calculating a margin of the normal range from a width of the normal range, and adding the margin to the normal range.

9. The abnormality detection device according to claim 2, wherein
when lengths of the waveforms of one or more pieces of learning outlier data whose waveforms have been determined to be of the same type are different, the processing circuitry calculates a degree of similarity between a piece of learning outlier data having a longer waveform length and a piece of learning outlier data having a shorter waveform length for each of the pieces of learning outlier data while shifting a position of the waveform having a shorter length with respect to the waveform having a longer length, and determines a maximum value out of the calculated degrees of similarity as a degree of similarity between the piece of learning outlier data having a longer waveform length and the piece of learning outlier data having a shorter waveform length.

10. The abnormality detection device according to claim 1, wherein
the processing circuitry calculates a mean value of waveforms of the respective pieces of learning outlier data whose waveforms have been determined to be of the same type, subtracts the mean value of the waveforms of the respective pieces of learning outlier data from each of the waveforms of the pieces of learning outlier data, and generates a waveform condition corresponding to the type from each of the waveforms of the pieces of learning outlier data obtained by subtracting the mean value.

11. The abnormality detection device according to claim 10, wherein
the processing circuitry calculates a standard deviation of waveforms of the respective pieces of learning outlier data whose waveforms have been determined to be of the same type, divides the waveform of each of the pieces of learning outlier data obtained by subtracting the mean value by the each standard deviation, and generates a waveform condition corresponding to the type from each of the waveforms of the pieces of learning outlier data obtained by division by the standard deviation.

12. The abnormality detection device according to claim 1, wherein
the processing circuitry presents a waveform condition generated, accepts selection of only an effective waveform condition from among the presented waveform conditions, leaves only the effective waveform condition whose selection has been accepted as the waveform condition generated, and discards a waveform condition whose selection has not been accepted.

13. The abnormality detection device according to claim 1, wherein
the processing circuitry:
calculates a feature amount of a piece of abnormality detection outlier data collated with a waveform condition when determines that the equipment is operating abnormally, and determines a waveform type of the piece of abnormality detection outlier data collated with the waveform condition from the feature amount, and
generates, from waveforms of one or more pieces of outlier data whose waveforms have been determined to be of the same type out of the pieces of learning outlier data and the pieces of abnormality detection outlier data collated with the waveform condition, a waveform condition corresponding to the type.

14. An abnormality detection method comprising:
calculating, from abnormality detection time-series data indicating states of equipment which is an abnormality detection target at a plurality of times in time series, a degree of abnormality of the equipment at each of the plurality of times as an abnormality detection outlier score;
extracting, from among pieces of the abnormality detection time-series data, a piece of abnormality detection time-series data in a time period in which an abnormality may have occurred in the equipment as abnormality detection outlier data on a basis of the abnormality detection outlier score at each of the plurality of times calculated;
collating a waveform of the abnormality detection outlier data extracted with a waveform condition for determining that a waveform indicating a change in the abnormality detection outlier data is a waveform obtained when the equipment is operating normally, and determining whether or not the equipment is operating abnormally on a basis of a collation result between the waveform condition and the waveform of the abnormality detection outlier data;
calculating a feature amount of the abnormality detection outlier data extracted by the outlier data extracting unit and determining a waveform type of the abnormality detection outlier data from the feature amount;
selecting a waveform condition corresponding to the type determined by the type determining unit from among one or more waveform conditions;
collating the waveform condition selected by the waveform condition selecting unit with the waveform of the abnormality detection outlier data, and determining whether or not the equipment is operating abnormally on a basis of a collation result between the selected waveform condition and the waveform of the abnormality detection outlier data;
calculating, from each of one or more pieces of learning time-series data indicating states of the equipment at a plurality of times when the equipment is operating normally in time series, a degree of abnormality of the equipment at each of the plurality of times as a learning outlier score;
extracting, from among the pieces of learning time-series data, learning time-series data in a time period in which an abnormality may have occurred in the equipment as learning outlier data on a basis of the learning outlier score at each of the plurality of times;
calculating a feature amount of each of the pieces of learning outlier data, and determining a waveform type of each of the pieces of learning outlier data from the feature amount of each of the pieces of learning outlier data; and
generating, from among waveforms of one or more pieces of learning outlier data whose waveforms have been determined to be of the same type out of the pieces of learning outlier data, a waveform condition corresponding to the type.
